(19) United States
(12) Patent Application Publication
(10) Pub. No.: US 2010/0149392 A1
(43) Pub. Date: Jun. 17, 2010

(54) SOLID-STATE IMAGING DEVICE, DRIVING METHOD THEREOF, AND IMAGING DEVICE

(75) Inventor: Kunihiko Hara, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/636,088

(22) Filed: Dec. 11, 2009

(30) Foreign Application Priority Data
Dec. 16, 2008 (JP) 2008-320328

(51) Int. Cl. H04N 5/335

(52) U.S. Cl. 348/300; 348/E05.091

(57) ABSTRACT

A solid-state imaging device according to an aspect of the present invention includes: an imaging unit which includes pixel units arranged in rows and columns; a row select unit which selects at least one row of the pixel units; column signal lines respectively provided for the columns, and transmit pixel signals from the selected at least one row of the pixel units; amplifier circuits respectively provided for the columns, and each includes an input terminal connected to a corresponding column signal line and an output terminal through which the amplifier circuit outputs an amplified pixel signal; switch circuits respectively provided for the columns, and each switches ON and OFF of a corresponding amplifier circuit; and bypass circuits respectively provided for the columns, and each allows a pixel signal to bypass from the input terminal to the output terminal of a corresponding amplifier circuit when the corresponding amplifier circuit is OFF.

### BACKGROUND OF THE INVENTION

(1) Field of the Invention

The present invention relates to a solid-state imaging device in which pixels that photoelectrically convert incident light are arranged two-dimensionally on a semiconductor substrate, an imaging device, and a driving method of the solid-state imaging device.

(2) Description of the Related Art

A MOS image sensor exhibits excellent characteristics such as high-speed and high-sensitivity. The market for a digital single lens reflex camera (DSLR) is expanding rapidly in recent years. Generally, the MOS image sensor includes an imaging unit and a column circuit as described in patent reference 1 (Japanese Unexamined Patent Application Publication No. 2003-51989) (FIG. 30).

In the imaging unit in which pixels that photoelectrically convert incident light are two-dimensionally arranged, a reset operation, a charge accumulation operation, and a readout operation are performed on a row-by-row basis. Output of pixels in each column are connected to a vertical signal line provided for each column. On the other hand, the column circuit is composed on a column-by-column basis, and includes a unit to hold an analog signal from a pixel after being amplified by a column amplifier. Each vertical signal line in the imaging unit is connected to a corresponding column circuit, so that pixel signals can be read out on a row-by-row basis. Every set of pixel signals obtained from one row and held in the column circuit are sequentially outputted to the outside of the chip by a horizontal readout circuit including a common horizontal signal line and an output amplifier. Signal amplification performed by the column amplifier relatively reduces the influences of noise generated in the subsequent circuits, thereby allowing high-quality image capture.

### SUMMARY OF THE INVENTION

Originally, the digital single lens reflex camera utilized the MOS image sensor only for still image capture, and utilized a conventional optical viewfinder as a viewfinder. On the other hand, a camera having a so called live-view function is becoming mainstream in recent years. More specifically, such a camera is becoming mainstream that also includes an electronic viewfinder which provides, on a small liquid crystal display included in the camera body, real-time display of an image detected by an image sensor. There are two methods for providing a live-view display. One is a method in which the MOS image sensor performs both moving image capture for live-view display, and still image capture. The other method is a method in which a dedicated image sensor (such as a small CCD sensor) performs moving image capture for live-view display, and the MOS image sensor performs still image capture. Although the second method involves high manufacturing cost, it has been adopted due to the following reasons.

In the image sensor disclosed in the patent reference 1, a large number of column amplifiers are provided (for example, a camera having 12M pixels includes 3,000 column amplifiers), which results in heavy power consumption. This causes a problem (referred to as a first problem) that application of such image sensor to a camera having an electronic viewfinder greatly raises the temperature of the sensor due to generated heat.

The temperature rise results in image degradation caused by an increase in leak current, and abnormal operation in a control circuit, thereby imposing significant restrictions on environmental temperature in which the electronic viewfinder can be used. Since it is difficult for a camera which has a small body to release heat, the above problem becomes more serious for such cameras.

Furthermore, with respect to the first problem, since resolution of the liquid crystal display is relatively low, power consumption in the horizontal readout unit can be reduced by mixing signals in the column circuit of the sensor to reduce the output pixel count. However, there is a problem (referred to as a second problem) that power consumption generated in the column amplifiers cannot be reduced.

Furthermore, there is also a problem (referred to as a third problem) that although power consumption in the column amplifiers can be reduced by thinning a part of the pixels in the imaging unit and reading them out, moiré occurs in an output image.

In view of the above problems, the present invention has an object to provide a solid-state imaging device and an imaging device which can perform high-quality still image capture and can also perform moving image capture for a monitor with low power consumption suitable for an electronic viewfinder.

In order to achieve the above object, the solid-state imaging device according to an aspect of the present invention includes: an imaging unit including pixel units arranged in rows and columns, the pixel units generating pixel signals each according to an amount of light received; a row select unit which selects at least one row of the pixel units; column signal lines which are respectively provided for the columns, and transmit pixel signals from the selected at least one row of the pixel units; amplifier circuits which are respectively provided for the columns, and each of which includes an input terminal and an output terminal, the input terminal being connected to a corresponding one of the column signal lines, each of the amplifier circuits outputting an amplified pixel signal through the output terminal; switch circuits which are respectively provided for the columns, and each of which switches ON and OFF of a corresponding one of the amplifier circuits; and bypass circuits which are respectively provided for the columns, and each of which allows a pixel signal to bypass from the input terminal to the output terminal of a corresponding one of the amplifier circuits when the corresponding one of the amplifier circuits is OFF.

With this structure, an amount of heat generated in the solid-state imaging device can be greatly reduced by switching the amplifier circuit OFF. For example, in a still image capture mode where a single-action operation is performed, it is possible to capture a high-quality still image by switching each amplifier circuit ON. Further, in a moving image capture mode where a continuous operation is performed, it is possible to greatly reduce power consumption and the amount of generated heat by switching each amplifier circuit OFF. In such a manner, reduction of the amount of generated heat allows reduction of noise included in a still image captured in the still image capture mode made immediately after the moving image capture mode, thereby allowing significant reduction of image degradation. Even when capturing moving image for a monitor for a long period of time, the amount of generated heat can be reduced, and high-quality still image can also be achieved.

Further, by switching the amplifier circuit ON, the influences of noise generated in the subsequent circuits of the amplifier circuit is reduced. Thus, it is possible to obtain a high-quality image which does not have the influences of the noise.

Here, the solid-state imaging device may further include a mixer circuit which mixes a predetermined number of pixel signals outputted from at least one the output terminal.

With this structure, a so called white defect and moiré can be reduced by performing mixing.

Here, it may be that the mixer circuit mixes the predetermined number of the pixel signals when each of the amplifier circuits is OFF.

Here, it may be that each of the switch circuits switches the corresponding one of the amplifier circuits OFF in a moving image capture mode for a monitor, and ON in a still image capture mode.

With this structure, even when capturing a high-resolution still image after capturing a moving image for a monitor having resolution lowered by mixing, the noise due to the generated heat can be reduced, and the noise included in the high-resolution still image can also be greatly reduced in the still image capture mode, since the amount of the generated heat is reduced in the moving capture mode for a monitor. As described, it is possible to provide a solid-state imaging device which is suitable for a digital single lens reflex camera having a so called live-view function.

Here, it may be that the solid-state imaging device includes: sample-and-hold circuits which are respectively provided for the columns, and each of which samples and holds, in a capacitance element, a pixel signal outputted through the output terminal, the capacitance element being included in each of the sample and hold circuits; and a column select circuit which selects at least one of the sample and hold circuits, in which the column select circuit sequentially selects the sample and hold circuits one by one when each of the amplifier circuits is ON, and the column select circuit sequentially makes a simultaneous selection of the predetermined number of the sample and hold circuits when each of the amplifier circuits is OFF, and the mixer circuit includes the predetermined number of capacitance elements included in the predetermined number of the sample and hold circuits, and mixes the predetermined number of the pixel signals based on the simultaneous selection.

With this structure, it is possible to easily achieve a mixer circuit which mixes a predetermined number of pixel signals in a horizontal direction (that is, a row direction). More particularly, since an existing capacitance element functions as a mixer circuit, it is possible to easily achieve a mixer circuit without substantially adding a dedicated mixer circuit.

Here, it may be that the mixer circuit mixes the predetermined number of the pixel signals which are from a same column and are outputted through the output terminal.

Here, it may be that the solid-state imaging device includes: sample-and-hold circuits which are respectively provided for the columns, and each of which samples and holds, in each of the predetermined number of capacitance elements, a pixel signal outputted through the output terminal, the predetermined number of capacitance elements being included in each of the sample-and-hold circuits; and a column select circuit which sequentially selects the sample and hold circuits, in which each of the sample-and-hold circuits samples and holds the predetermined number of the pixel signals that are from different rows, in the predetermined number of the capacitance elements, when each of the amplifier circuits is OFF, and the mixer circuit includes the predetermined number of the capacitance elements, and mixes the predetermined number of the pixel signals held based on the selection made by the column select circuit.

With this structure, it is possible to easily achieve a mixer circuit which mixes a predetermined number of pixel signals in a vertical direction (that is, a column direction).

Here, it may be that each of the column signal lines includes: a first signal line; and a second signal line, pixel units in a same column, among the pixel units, include: a pixel unit connected to the first signal line; and a pixel unit connected to the second signal line, each of the amplifier circuits includes: an amplifier element; an input capacitance element connected between the amplifier element and the input terminal of the amplifier circuit; and a feedback capacitance element connected between an input and an output of the amplifier element. It also may be that the solid-state imaging device further includes: clamp circuits which are respectively provided for the columns, and each of which clamps a pixel signal outputted through the output terminal to a clamp capacitance element, the clamp capacitance element being included in each of the clamp circuits, when the corresponding one of the amplifier circuits is OFF, each of the bypass circuits allows a pixel signal that is from a corresponding first signal line to bypass to the output terminal, and further clamps a pixel signal that is from a corresponding second signal line to at least one of the input capacitance element and the feedback capacitance element, and the mixer circuit includes the clamp capacitance element and at least one of the input capacitance element and the feedback capacitance element, and mixes the pixel signals which have been clamped, when each of the amplifier circuits is OFF.

With this structure, an input capacitance element or feedback capacitance element in the amplifier circuit is further used as a clamp capacitance element which is a different function from the original function. Thus gain of the clamp operation increases, thereby reducing the influences of noise generated in the circuits of the subsequent stages. Furthermore, it is also possible to improve frame rate by reading out pixel signals obtained from two rows at the same time.

Here, it may be that at least two pixel units among the pixel units constitute one cell, the at least two pixel units being adjacent to each other in a same column, the one cell includes: a first photoelectric conversion element; a second photoelectric conversion element; a floating diffusion layer; a first transfer unit which transfers a signal charge from the first photoelectric conversion element to the floating diffusion layer; a second transfer unit which transfers a signal charge from the second photoelectric conversion element to the floating diffusion layer; and an amplifier unit which converts a signal charge in the floating diffusion layer into a voltage, and outputs the converted voltage as a pixel signal, and when each of the amplifier circuits is OFF, the signal charge transferred by the first transfer unit and the signal charge transferred by the second transfer unit are mixed in the floating diffusion layer.

With this structure, it is further possible to reduce circuit area of the pixel units since a plurality of pixel units in each cell share a floating diffusion layer and an amplifier unit. Furthermore, by reading out pixel signals from two rows at the same time, frame rate can also be improved.

Here, it may be that the solid-state imaging device further includes analog-to-digital (AD) converters which are respectively provided for the columns, and each of which converts a pixel signal outputted through the output terminal into a digital pixel signal, in which the mixer circuit mixes the predetermined number of digital pixel signals.

Further, with this structure, since the mixer unit mixes digital pixel signals, even digital pixel signals having small values do not have the influences of noise. Thus, the image quality of dark area in an image can be improved.

Here, it may be that each of the AD converters is capable of switching an input range of the pixel signal, and when each of the amplifier circuits is OFF, the input range is narrower than the input range of the case where each of the amplifier circuits is ON.

With this structure, it is possible to shorten time required for AD conversion performed by the AD convertor when each amplifier circuit is OFF, thereby improving frame rate.

Here, it may be that each of the amplifier circuits includes: an amplifier element; and an input capacitance element inserted between the input terminal of the amplifier circuit and the amplifier element. It also may be that the solid-state imaging device further includes: clamp circuits which are respectively provided for the columns, and each of which clamps a pixel signal outputted through the output terminal to a clamp capacitance element, the clamp capacitance element being included in each of the clamp circuits; and connect circuits which are respectively provided for the columns, and each of which connects in parallel the input capacitance element and the clamp capacitance element when each of the amplifier circuits is OFF.

With this structure, it is possible to use an input capacitance element in the amplifier circuit as a clamp capacitance element which is a function different from the original function. As a result, gain of the clamp operation increases, thereby reducing the influences of noise generated in the subsequent circuits.

Here, it may be that each of the amplifier circuits further includes a feedback capacitance element inserted between an output and an input of the amplifier element, and the connect circuit further connects in parallel the feedback capacitance element and the clamp capacitance element when each of the amplifier circuits is OFF.

Further, with this structure, it is possible to use a feedback capacitor in the amplifier circuit as a clamp capacitance element which is a function different from the original function. As a result, gain of the clamp operation increases, thereby reducing the influences of noise generated in the subsequent circuits.

Further, the solid-state imaging device according to an aspect of the present invention includes an image processing unit which reduces noise included in an image captured by the solid-state imaging device.

With this structure, it is possible to restore image quality degraded due to noise generated in the solid-state imaging device.

Here, it may be that the image processing unit includes: a storing unit that stores a position of a pixel unit, among the pixel units, which always causes the noise in the imaging unit; and an interpolation unit which interpolates, in the image captured by the solid-state imaging device, a pixel data corresponding to the position stored in the storing unit.

With this structure, it is possible to improve image quality by removing pixel signals that become white defects resulting from lattice defects or the like that are specific to the imaging unit of the solid-state imaging device.

Here, it may be that the image processing unit reduces the noise by performing filtering processing on the image captured by the solid-state imaging device.

With this structure, it is possible to make image degradation due to noise generated in the solid-state imaging device, less noticeable.

Further, a method for driving a solid-state imaging device according to an aspect of the present invention is a method for driving a solid-state imaging device, and the solid-state imaging device includes: an imaging unit including pixel units arranged in rows and columns, the pixel units generating pixel signals each according to an amount of light received; a row select unit which selects at least one row of the pixel units; column signal lines which are respectively provided for the columns, and transmit pixel signals from the selected at least one row of the pixel units; amplifier circuits which are respectively provided for the columns, and each of which includes an input terminal and an output terminal, the input terminal being connected to a corresponding one of the column signal lines, each of the amplifier circuits outputting an amplified pixel signal through the output terminal. The method for driving the solid-state imaging device includes: detecting a switchover between a moving image capture mode for a monitor and a still image capture mode; switching each of the amplifier circuits ON when the switchover into the still image capture mode is detected; switching each of the amplifier circuits OFF when the switchover into the moving image capture mode for a monitor is detected; allowing a pixel signal to bypass from the input terminal to the output terminal of a corresponding one of the amplifier circuits when the switchover into the motion image capture mode for a monitor is detected; and mixing a predetermined number of pixel signals outputted from at least one the output terminal.

With this structure, it is possible to obtain the same advantageous effects as the above.

According to the solid-state imaging device of the present invention, it is possible to easily achieve a digital single lens reflex camera having a high-quality still image capture function and an electronic viewfinder function that can be used in a wide-ranging environmental temperature, a digital single lens camera having a mirror-less structure (that is, having no structure in which reflex is caused by a mirror), and a lens-fixed type digital still camera.

### FURTHER INFORMATION ABOUT TECHNICAL BACKGROUND TO THIS APPLICATION

The disclosure of Japanese Patent Application No. 2008-320328 filed on Dec. 16, 2008 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing an overall structure of a solid-state imaging device according to a first embodiment of the present invention;

FIG. 2 is a diagram showing structures of pixel units of the solid-state imaging device according to the first embodiment of the present invention;

FIG. 3A is a diagram showing a first example of a column amplifier according to the first embodiment of the present invention;

FIG. 3B is a diagram showing a second example of the column amplifier according to the first embodiment of the present invention;

FIG. 3C is a diagram showing a third example of the column amplifier according to the first embodiment of the present invention;

FIG. 4 is a diagram showing a structure of a column circuit of the solid-state imaging device according to the first embodiment of the present invention;

FIG. 5A is a diagram showing a surrounding structure of a multiplexer unit of the solid-state imaging device according to the first embodiment of the present invention;

FIG. 5B is a diagram showing a variation of a S/H circuit and a MUX circuit according to the first embodiment of the present invention;

FIG. 6 is a diagram showing timing of each control signal related to readout in a vertical direction in an all-pixel readout mode of the solid-state imaging device according to the first embodiment of the present invention;

FIG. 7 is a diagram showing timing of each control signal related to readout in a horizontal direction in an all-pixel readout mode of the solid-state imaging device according to the first embodiment of the present invention;

FIG. 8 is a diagram showing timing of each control signal related to readout in a vertical direction in a pixel mixing mode of the solid-state imaging device according to the first embodiment of the present invention;

FIG. 9 is a diagram showing timing of each control signal related to readout in a horizontal direction in a pixel mixing mode of the solid-state imaging device according to the first embodiment of the present invention;

FIG. 10A is a diagram showing a structure of a column circuit of a solid-state imaging device according to a second embodiment of the present invention;

FIG. 10B is a diagram showing an equivalent circuit of FIG. 10A in the case where a column amplifier is OFF according to the second embodiment of the present invention;

FIG. 11 is a diagram showing timing of each control signal related to readout in a vertical direction in an all-pixel readout mode of the solid-state imaging device according to the second embodiment of the present invention;

FIG. 12 is a diagram showing timing of each control signal related to readout in a horizontal direction in an all-pixel readout mode of the solid-state imaging device according to the second embodiment of the present invention;

FIG. 13 is a diagram showing timing of each control signal related to readout in a vertical direction in a pixel mixing mode of the solid-state imaging device according to the second embodiment of the present invention;

FIG. 14 is a diagram showing timing of each control signal related to readout in a horizontal direction in a pixel mixing mode of the solid-state imaging device according to the second embodiment of the present invention;

FIG. 15 is a diagram showing an overall structure of a solid-state imaging device according to a third embodiment of the present invention;

FIG. 16 is a diagram showing a structure of a column amplifier unit of the solid-state imaging device according to the third embodiment of the present invention;

FIG. 17A is a diagram showing an operation of a column ADC of the solid-state imaging device according to the third embodiment of the present invention;

FIG. 17B is a diagram showing an operation in the case where input range of the column ADC of the solid-state imaging device is limited, according to the third embodiment of the present invention;

FIG. 18 is a diagram showing an overall structure of a solid-state imaging device according to a fourth embodiment of the present invention;

FIG. 19 is a diagram showing structures of pixel units of the solid-state imaging device according to the fourth embodiment of the present invention;

FIG. 20 is a diagram showing timing of each control signal related to readout in a vertical direction in an all-pixel readout mode of the solid-state imaging device according to the fourth embodiment of the present invention;

FIG. 21 is a diagram showing timing of each control signal related to readout in a vertical direction in a pixel mixing mode of the solid-state imaging device according to the fourth embodiment of the present invention;

FIG. 22 is a diagram showing an overall structure of a solid-state imaging device according to a fifth embodiment of the present invention;

FIG. 23 is a diagram showing structures of pixel units of the solid-state imaging device according to a fifth embodiment of the present invention;

FIG. 24 is a diagram showing a structure of a column circuit of the solid-state imaging device according to a fifth embodiment of the present invention;

FIG. 25A is a diagram showing an equivalent circuit of the column circuit in an all-pixel readout mode according to the fifth embodiment of the present invention;

FIG. 25B is a diagram showing an equivalent circuit of the column circuit in an all-pixel mixing mode according to the fifth embodiment of the present invention;

FIG. 26 is a diagram showing timing of each control signal related to readout in a vertical direction in an all-pixel readout mode of the solid-state imaging device according to the fifth embodiment of the present invention;

FIG. 27 is a diagram showing timing of each control signal related to readout in a vertical direction in a pixel mixing mode of the solid-state imaging device according to the fifth embodiment of the present invention;

FIG. 28 is a diagram showing a structure of a camera (imaging device) according to a sixth embodiment;

FIG. 29 is a flowchart showing a flow of an imaging operation of the camera (imaging device) according to the sixth embodiment; and

FIG. 30 is a diagram showing an overall structure of a solid-state imaging device according to a conventional technique.

### DESCRIPTION OF THE PREFERRED EMBODIMENT(S)

Hereinafter, embodiments of a solid-state imaging device according to the present invention will be described in detail with reference to the drawings. Note that a single lens reflex camera and a single lens camera are both referred to as a single lens reflex camera in the following embodiments.

### First Embodiment

A solid-state imaging device according to the first embodiment is a solid-state imaging device which includes a column amplifier unit made up of amplifier circuits (column amplifier) provided for each column. The solid-state imaging device includes: switch circuits provided for each column, and each of which switches ON and OFF of a corresponding amplifier circuit; and bypass circuits provided for each column, and each of which allows pixel signals to bypass from the input terminal to the output terminal of a corresponding amplifier circuit. With this structure, an amount of heat generated in the solid-state imaging device can be greatly reduced by switching each amplifier circuit OFF. For example, in a moving image capture mode where a continuous operation is performed, it is possible to greatly reduce power consumption and the amount of generated heat by switching each amplifier circuit OFF. Reduction of the amount of generated heat allows reduction of noise included in a still image captured in a still image capture mode made immediately after the moving image capture mode, thereby allowing significant reduction of image degradation. Even when capturing a moving image for a monitor for a long period of time, the amount of generated heat can be reduced, and high-quality still image can also be achieved.

Furthermore, the solid-state imaging device according to the first embodiment includes a mixer circuit which mixes a predetermined number of pixel signals. The mixer circuit mixes the predetermined number of pixel signals when each amplifier circuit is OFF. Further, the switch circuit switches each amplifier circuit OFF in a moving image capture mode for a monitor, and ON in a still image capture mode. Even when capturing a high-resolution still image after capturing a moving image for a monitor having resolution lowered by mixing, the noise due to the generated heat can be reduced, and the noise included in the high-resolution still image can also be greatly reduced in the still image capture mode, since the amount of the generated heat is reduced in the moving capture mode for a monitor. As described, the solid-state imaging device according to the first embodiment is suitable for a digital single lens reflex camera having a so-called live-view function.

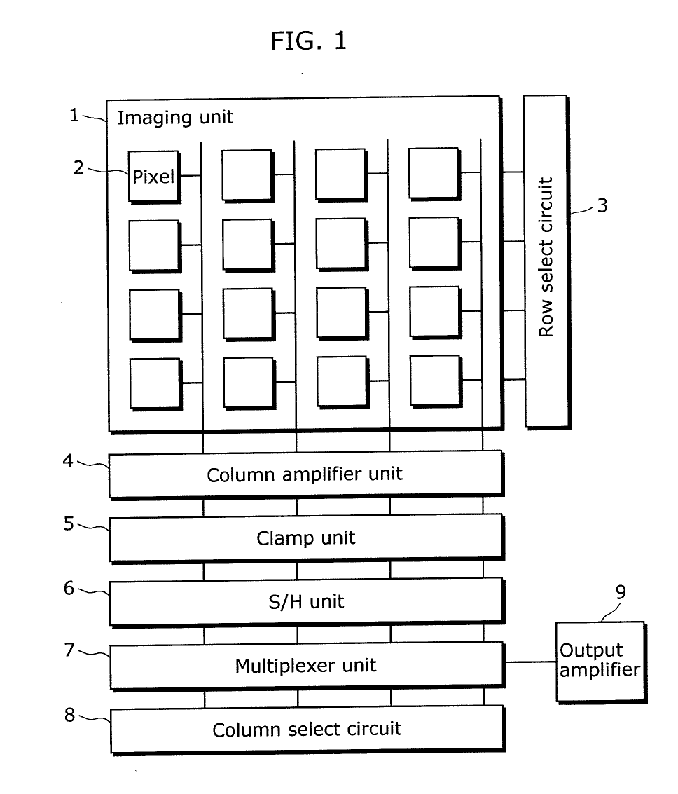

FIG. 1 is a diagram showing an overall structure of the solid-state imaging device according to the first embodiment of the present invention. As seen in FIG. 1, the solid-state imaging device includes an imaging unit 1, a row select circuit 3, a column amplifier unit 4, a clamp unit 5, a sample and hold (S/H) unit 6, a multiplexer (MUX) unit 7, a column select circuit 8, and an output amplifier 9. The imaging unit 1 is an imaging area in which pixel units 2 for performing photoelectric conversion are two-dimensionally arranged. Here, 16 pixels which are two dimensionally arranged by 4×4 are shown; however, the actual total pixels are over several megapixels.

The row select circuit 3 is connected to, for each row, three control lines of a row select signal SEL, a pixel reset signal RST, and a charge transfer signal TRAN. The row select circuit 3 controls a reset (initialization) operation, a read (readout) operation, and a line select operation on a row-by-row basis with respect to each pixel unit in the imaging unit 1.

The column amplifier unit 4 includes a plurality of column amplifiers 4a, each of which is a basic unit, and which are arranged in a row direction, and amplifies output supplied on a row-by-row basis from the imaging unit 1.

The clamp unit 5 includes a plurality of clamp circuits 5a, each of which is a basic unit, and which are arranged in a row direction, and removes fixed pattern noise component generated in the pixel units 2, from among the row-by-row basis outputs supplied from the column amplifier unit 4.

The S/H unit 6 includes a plurality of S/H circuit 6a, each of which is a basic unit, and which are arranged in a row direction, and samples and holds output supplied on a row-by-row basis from the clamp unit 5.

The MUX unit 7 includes a plurality of unit circuits 7a, each of which is a basic unit, and which are arranged in a row direction, and switches connection between each S/H circuit 6a in the S/H unit 6 and a common horizontal signal line 43.

The column select circuit 8 includes control lines, and sequentially selects columns of the MUX unit 7. The output amplifier 9 receives output of the S/H circuit 6a through the MUX unit 7 and the common horizontal signal line 43, and amplifies the received output for outputting to the outside of the chip.

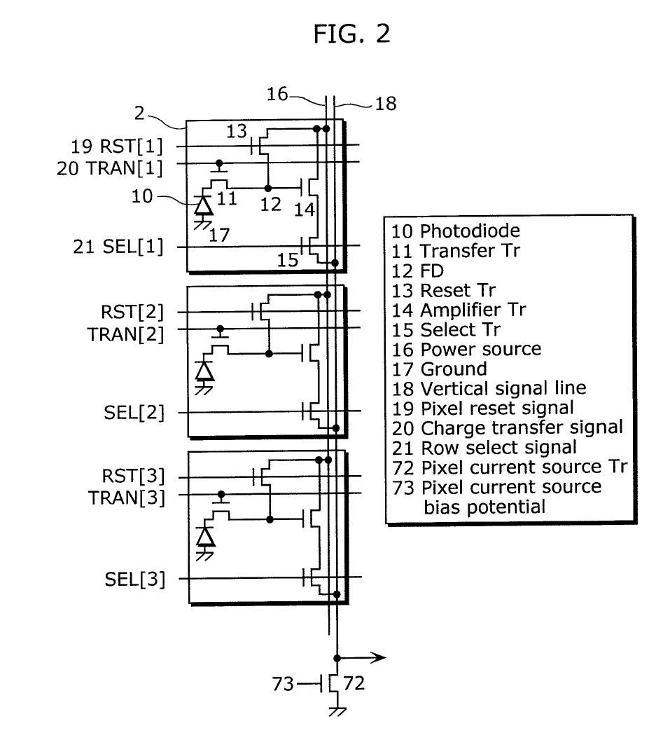

FIG. 2 is a circuit diagram showing the details of the pixel units 2 arranged in a column direction. As seen in FIG. 2, each of the pixel units 2 has a feature in that the pixel unit 2 outputs, to a vertical signal line (also referred to as a column signal line) 18, a reset voltage in which voltage at the time of initialization is amplified, and a read voltage in which voltage at the time of readout is amplified. The pixel unit 2 includes: a photodiode (PD) 10 which photoelectrically converts incident light and outputs charge; a floating diffusion (FD) 12 which accumulates the charge generated by the PD10, and outputs the accumulated charge as a voltage signal; a reset transistor 13 (hereinafter, transistor may be abbreviated as “Tr”) which resets the voltage indicated by FD 12 to initial voltage (here, referred to as VDD); a transfer Tr 11 which provides the charge outputted by the PD 10 to the FD 12; an amplifier Tr 14 which outputs voltage which changes according to the voltage indicated by the FD12; and a select Tr 15 which connects the output of the amplifier Tr 14 to the vertical signal line 18 upon receiving a line select signal from the row select circuit 3. A pixel current source Tr 72 is provided for each column, and generates current to supply output of the amplifier Tr 14 to the vertical signal line 18.

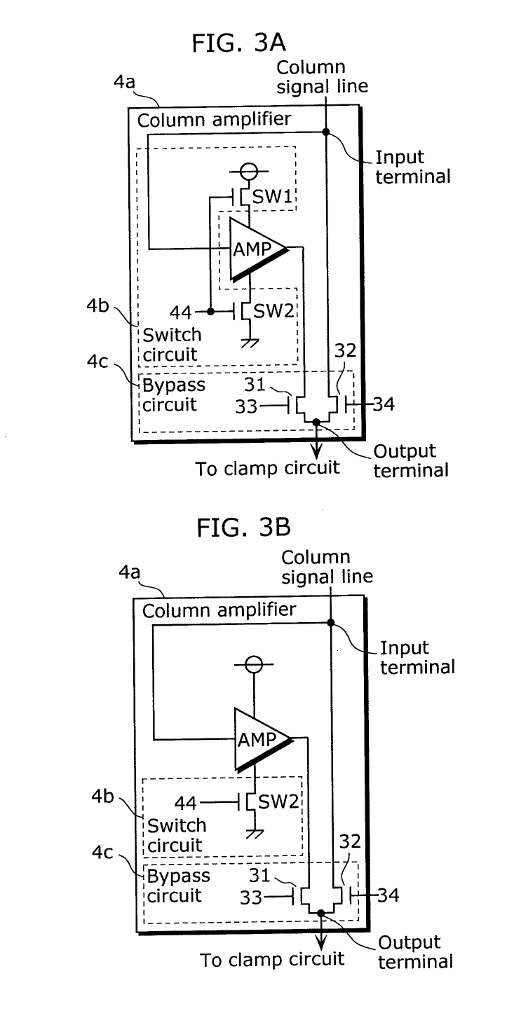

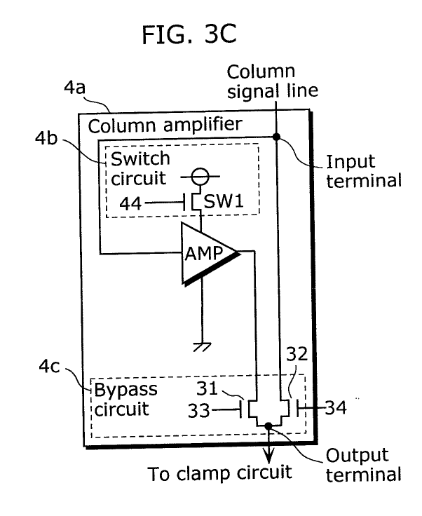

FIG. 3A is a diagram showing a first example of the column amplifier 4a according to the first embodiment of the present invention. The column amplifier 4a in FIG. 3A includes an amplifier element AMP, a switch circuit 4b, and a bypass circuit 4c.

The switch circuit 4b includes a switch transistor SW1 and a switch transistor SW2, and switches ON and OFF of the amplifier element AMP. The switch transistors SW1 and SW2 close when a power-saving inverse signal 44 is at a high level (hereinafter, simply referred to as H), and open when the power-saving inverse signal 44 is at a low level (hereinafter, simply referred to as L). Here, “ON” of the amplifier element AMP indicates that the amplifier element AMP performs amplification. Here, “OFF” of the amplifier element AMP indicates that the amplifier element AMP does not perform amplification, and does not consume electric power or current. In FIG. 3A, the amplifier element AMP is switched OFF by the two switch transistors SW1 and SW 2 blocking power supply.

The bypass circuit 4c allows pixel signals to bypass from the input terminal to the output terminal of the amplifier element AMP when the amplifier element AMP is OFF. The bypass circuit in FIG. 3A serves as a selector which selects either a pixel signal amplified by the amplifier element AMP or a bypassed non-amplified pixel signal.

FIG. 3B is a diagram showing a second example of the column amplifier 4a according to the first embodiment of the present invention. FIG. 3B is different from FIG. 3A only in that the switch transistor SW1 is deleted, but the operation is the same. Thus, the description of FIG. 3B is omitted.

FIG. 3C is a diagram showing a third example of the column amplifier 4a according to the first embodiment of the present invention. FIG. 3C is different from FIG. 3A only in that the switch transistor SW2 is deleted, but the operation is the same. Thus, the description of FIG. 3C is omitted.

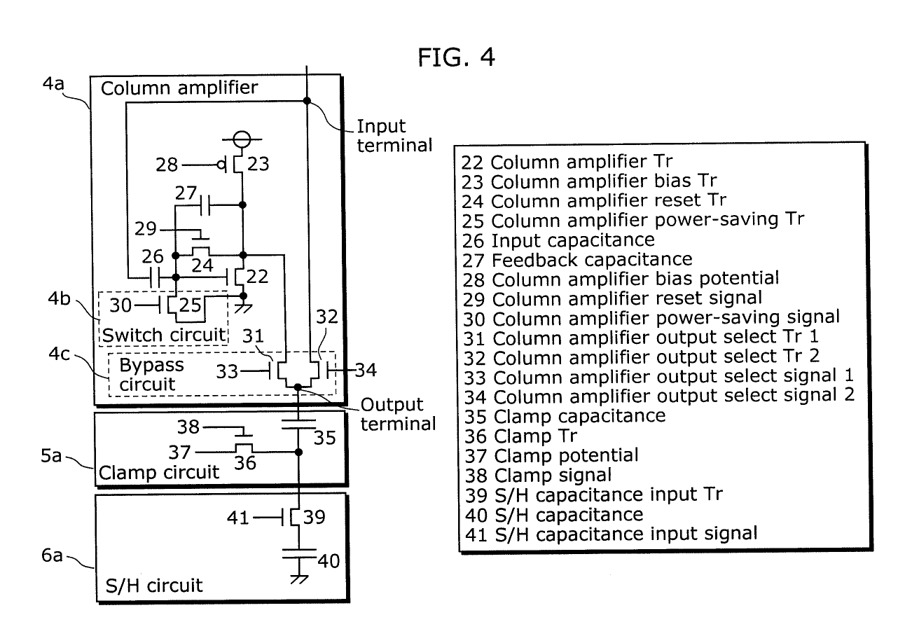

FIG. 4 is a diagram showing the details of the column circuit made up of the column amplifier 4a, the clamp circuit 5a, and the S/H circuit 6a. The column circuit serves to temporarily hold a signal indicating the difference between the reset voltage and the read voltage outputted from the pixel unit, and then output the held signal to the MUX unit 7. In FIG. 4, the switch circuit 4b is made up of a power-saving transistor 25. When a power-saving signal 30 is at L level, the power-saving transistor 25 is switched ON. As a result, the gate of the amplifier transistor 22 becomes a ground level, and the amplifier transistor 22 is switched OFF where amplification is not performed and current is not consumed.

As seen in FIG. 4, the column amplifier 4a includes: an input capacitance 26 (capacitance value Cin) which has one terminal to which signals from the pixel units 2 are inputted; a column amplifier Tr 22 which has a gate connected to the other terminal of the input capacitance 26, and which amplifies the signals from the pixel units 2; a column amplifier bias Tr 23 which has a gate connected to a column amplifier bias potential 28, and which supplies driving current to the amplifier Tr 22; a feedback capacitance 27 (capacitance value Cfb) which determines the gain of signal amplification performed by the column amplifier Tr 22; a column amplifier reset Tr 24 which has a gate to which a column amplifier reset signal 29 is supplied, and which performs a reset operation for setting the output of the column amplifier Tr 22 to a predetermined potential; a column amplifier power-saving Tr 25 which has a gate to which a column amplifier power-saving signal 30 is supplied, and which sets the gate potential of the column amplifier Tr 22 to the ground; a column amplifier output select Tr 1 (31) which has a gate to which an output select signal 1 (33) is supplied, and which connects the drain of the column amplifier Tr 22 with the output terminal of the column amplifier 4a; and a column amplifier output select Tr 2 (32) which has a gate to which an output select signal 2 (34) is supplied, and which directly connects the input terminal and the output terminal.

Further, when the column amplifier power-saving signal 30 is at L level, the output select signal 1 (33) is at H level, and the output select signal 2 (34) is at L level, the column amplifier 4a amplifies signals inputted from the pixel units 2 through the input terminal, and outputs the amplified signals to the clamp circuit 5a through the output terminal. At this time, the gain A is given by Cin/Cfb. On the other hand, when the column amplifier power-saving signal 30 is at H level, the output select signal 1 (33) is at L level, and the output select signal 2 (34) is at H level, the pixel signals inputted from the pixel units 2 through the input terminal bypass the bypass circuit 4c, and are directly outputted to the clamp circuit 5a through the output terminal. At this time, the gate of the amplifier Tr 22 becomes the ground potential; and thus, current supplied from the column amplifier bias Tr 23 is blocked, and the amplifier element AMP which principally includes the column amplifier Tr 22 is switched OFF.

Further, the clamp circuit 5a includes: a clamp capacitance 35 (capacitance value Ccl) which determines a pixel signal, that is the difference between the reset signal and the read signal inputted from the column amplifier 4a; and a clamp Tr 36 which has a gate to which a clamp signal 38 is supplied, and which sets, to the clamp potential VCL (37), the potential of the terminal of the clamp capacitance 35 at the side opposite to the column amplifier 4a. Further, the S/H circuit 6a includes a S/H capacitance 40 (capacitance value Csh) which has a gate to which a S/H capacitance input signal 41 is supplied, and which temporarily holds pixel signals, and a S/H capacitance input Tr 39 which inputs signals to the S/H capacitance 40.

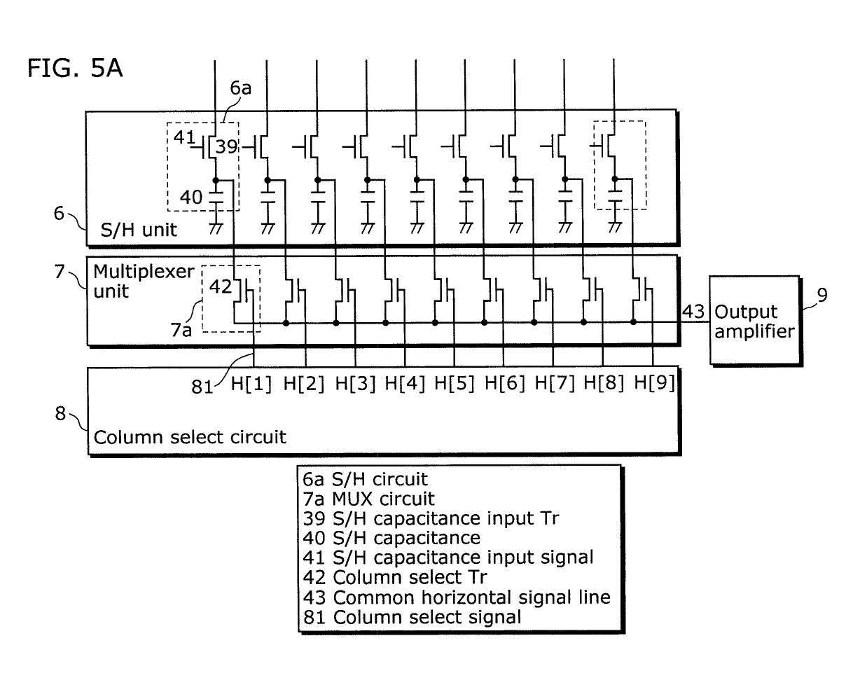

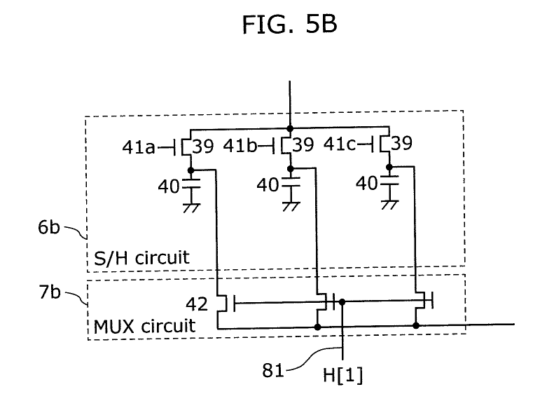

FIG. 5A is a circuit example showing the details of the MUX unit and the surrounding of the MUX unit. As seen in FIG. 5A, a column select Tr 42 is provided between each S/H capacitance 40 and the common horizontal signal line 43. The column select Tr 42 sequentially outputs, to the common horizontal signal line 43, the signals held by the S/H capacitance 40 according to the column select signal (H[n]) supplied to the gate of the column select Tr 42. The signals supplied to the output amplifier 9 through the common horizontal signal line 43 are outputted to the outside of the chip after being amplified.

Here, each pixel unit 2 receives a pixel reset signal (RST), a charge transfer signal (TRAN) and a row select signal (SEL). The column amplifier power-saving signal 30, the column amplifier reset signal 29, the column amplifier output select signals 1 (33) and 2(34), the clamp signal 38, the S/H capacitance input signal 41 are supplied to the column circuit (the column amplifier 4a, the clamp circuit 5a, the S/H circuit 6a) at a predetermined timing. A column select signal H[n] is supplied to the MUX unit 7 at a predetermined timing. Then, the transistors corresponding to each control signal is opened or closed (switched ON or OFF).

Further, the solid-state imaging device according to the first embodiment of the present invention includes an all-pixel readout mode that can be used for capturing a still image for a camera, and a pixel mixing mode that can be used for capturing a moving image for a camera monitor. Next, each signal readout operation is described.

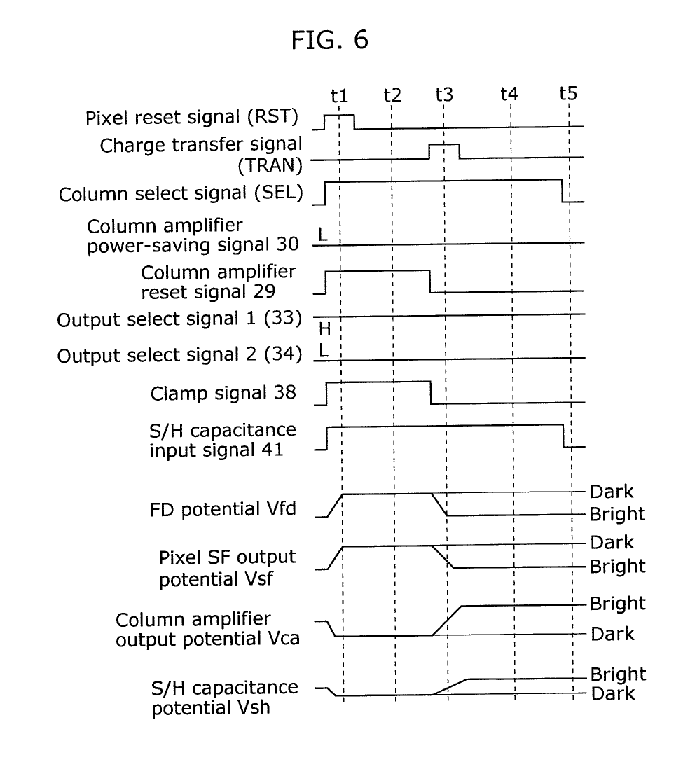

FIG. 6 is a diagram showing timing of each control signal supplied to the pixel units and the column circuits in the all-pixel readout mode.

As seen in FIG. 6, since the column amplifier power-saving signal 30 is at L level, the output select signal 1 (33) is at H level, and the output select signal 1 (34) is at L level, the column amplifier 4a amplifies the signal from the pixel unit 2 and outputs the amplified signal to the clamp circuit 5a.

At time t1, the transfer Tr 11 is OFF, the reset Tr 13 is ON, and the potential of the FD 12 (hereinafter referred to as Vfd) is initialized to the FD reset potential Vfdrst (=VDD).

At time t2, the transfer Tr 11 and the reset Tr 13 are OFF; and thus, the reset status of the FD potential is maintained. At this time, since the select Tr 15 is ON, the amplifier Tr 14 and the pixel current source Tr 72 form a source follower circuit, so that Vfdrst-Vth is outputted to the vertical signal line 18 as a reset voltage (although Vfdrst-Vth should be indicated as Vfdrst-Vth-α to be exact, a is omitted here). Furthermore, the reset voltage Vfdrst-Vth is inputted to the column amplifier 4a. In the column amplifier 4a, the column amplifier reset signal 29 is at H level; and thus, the gate and the drain of the column amplifier Tr 22 are shorted, so that the drain voltage becomes constant potential Vcarst which does not depend on the signal from the pixel unit 2, and the Vcarst is outputted to one terminal of the clamp capacitance 35. On the other hand, the clamp signal 38 and the S/H capacitance input signal 41 are at H level; and thus the other terminal of the clamp capacitance 35 and the potential of the S/H capacitance 40 is set to VCL.

At time t3, the transfer Tr 11 is made to be ON; and thus, charge accumulated in the PD 10 is transferred to the FD 12. As a result, the Vfd lowers by voltage Vfdsig corresponding to the signal charge amount, and becomes Vfdrst-Vfdsig.

At time t4, the transfer Tr 11 is OFF, and the select Tr 15 is ON; and thus Vfdrst-Vfdsig-Vth is outputted to the vertical signal line 18 as a read voltage. As a result, the input of the column amplifier 4a changes by Vfdsig; and thus, the output of the column amplifier 4a rises by Vfdsig×A (this is because the column amplifier reset signal 29 is at L level, and the reset status of the column amplifier 7a is released). Further, since the clamp Tr 36 is OFF, the potential of the other terminal of the clamp capacitance 35, that is, the potential of the S/H capacitance rises by Vfdsig×A×Ccl/(Ccl+Csh).

Such potential change is a voltage corresponding to the difference between the reset voltage and the read voltage in the vertical signal line 18, that is, a pixel signal. At time t5, the S/H capacitance input signal 41 is brought to the L level, and the pixel signal is written to the S/H capacitance 40.

Due to the above, pixel signals obtained from one row are held by the S/H unit 6.

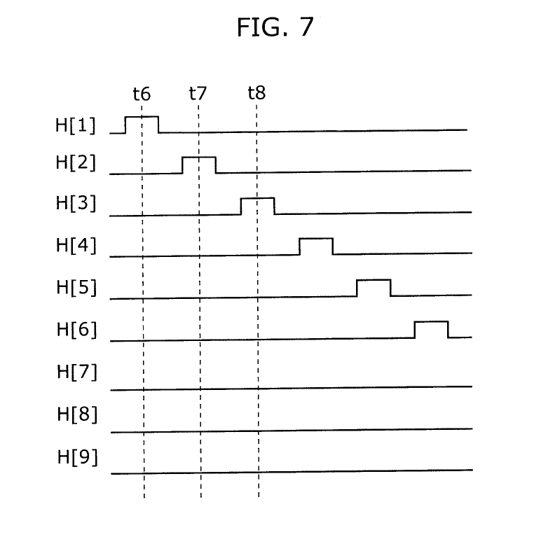

Next, FIG. 7 is a diagram showing timing of each control signal supplied to the MUX unit in the all-pixel readout mode.

At time t6, the column select signal H[1] is brought to the H level, and the column select Tr 42 in the column 1 is switched ON. As a result, the signal of the S/H capacitance 40 in the column 1 is outputted to the common horizontal signal line 43, and outputted to the outside through the output amplifier 9.

At time t7, the column select signal H[2] is brought to the H level, and the column select Tr 42 in the column 2 is switched ON. As a result, the signal of the S/H capacitance in the column 2 is outputted to the common horizontal signal line 43, and outputted to the outside through the output amplifier. In the same manner, when the column select signals are sequentially brought to the H level, signals of the S/H capacitance 40 in each column are sequentially outputted. Due to the above, pixel signals obtained from one row are sequentially outputted. Further, when operations in FIG. 6 and FIG. 7 are repeated as many as the number of rows that are in the imaging unit 1, signals in the whole imaging unit 1 are read out.

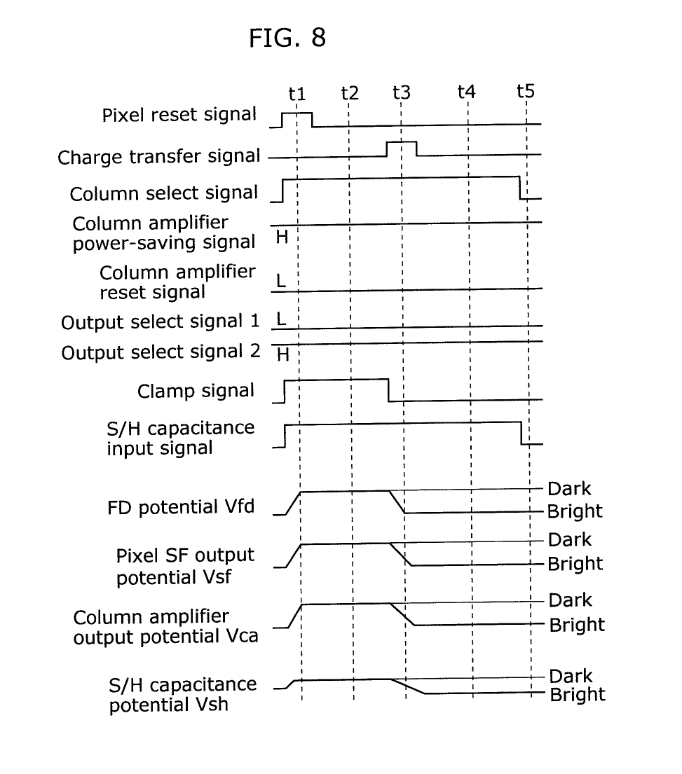

FIG. 8 is a diagram showing timing of each control signal supplied to the pixel units and the column circuits in the pixel mixing mode.

Since the column amplifier power-saving signal 30 is at H level, the output select signal 1 (33) is at L level, and the output select signal 2 (34) is at H level, the input to the column amplifier 4a is directly outputted to the clamp circuit 5a without being amplified.

At time t1, the transfer Tr 11 is OFF, the reset Tr 13 is ON, and the potential of the FD 12 (hereinafter referred to as Vfd) is initialized to the FD reset potential Vfdrst (=VDD).

At time t2, the transfer Tr 11 and the reset Tr 13 are OFF; and thus, the reset status of the FD potential is maintained. At this time, since the select Tr 15 is ON, the amplifier Tr 14 and the pixel current source Tr 72 form a source follower circuit, so that Vfdrst-Vth is outputted to the vertical signal line 18 as a reset voltage (although Vfdrst-Vth should be indicated as Vfdrst-Vth-α to be exact, α is omitted here). Further, the reset voltage Vfdrst-Vth is inputted to one terminal of the clamp capacitance 35. On the other hand, the clamp signal and the S/H capacitance input signal 41 are at H level, and the other terminal of the clamp capacitance 35 and the potential of the S/H capacitance 40 are fixed to VCL.

At time t3, the transfer Tr 11 is switched ON; and thus, charge accumulated in the PD 10 is transferred to the FD 12. As a result, the Vfd lowers by voltage Vfdsig corresponding to the signal charge amount, and becomes Vfdrst-Vfdsig.

At time t4, the transfer Tr 11 is OFF, and the select Tr 15 is ON; and thus Vfdrst-Vfdsig-Vth is outputted to the vertical signal line 18 as a read voltage. As a result, the input of the clamp capacitance 35 changes by Vfdsig.

Further, since the clamp Tr 36 is OFF, the potential of the other terminal of the clamp capacitance 35, that is, the potential of the S/H capacitance 40 lowers by Vfdsig×Ccl/(Ccl+Csh). Such potential change is a voltage corresponding to the difference between the reset voltage and read voltage in the vertical signal line 18, that is, a pixel signal. At time t5, the S/H capacitance input signal 41 is brought to the L level, and the pixel signal is written to the S/H capacitance 40.

Due to the above, pixel signals obtained from one row are held by the S/H unit 6.

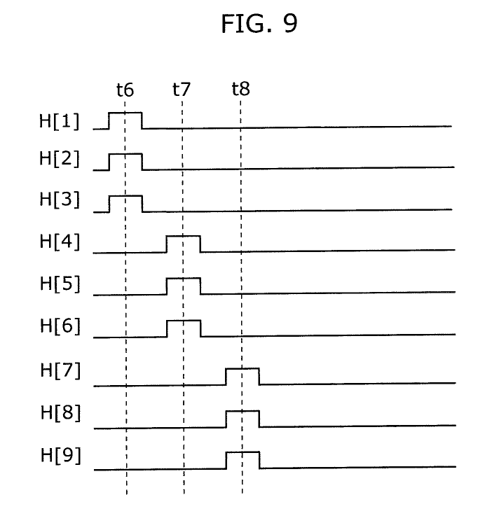

Next, FIG. 9 is a diagram showing timing of each control signal supplied to the MUX unit in the pixel mixing mode.

At time t6, the three column select signals H[1], H[2], and H[3] are brought to the H level, and the column select transistors 42 in the columns 1, 2, and 3 are switched ON. As a result, the signals of the S/H capacitances 40 in the columns 1, 2, and 3 are simultaneously outputted to the common horizontal signal line 43, and outputted to the outside through the output amplifier after being mixed together.

At time t7, the three column select signals H[4], H[5], and H[6] are brought to the H level, and the column select transistors 42 in the columns 4, 5, 6 are switched ON. As a result, the signals of the S/H capacitances 40 in the columns 4, 5, and 6 are outputted to the common horizontal signal line 43, and outputted to the outside through the output amplifier 9 after being mixed together. In the same manner, when sets of three column select signals are brought to the H level, the signals of the S/H capacitance 40 in each column are sequentially mixed and outputted.

Due to the above, mixed pixel signals obtained from one row are sequentially outputted. Further, when operations in FIG. 8 and FIG. 9 are repeated as many as the number of rows that are in the imaging unit 1, mixed signals in the whole imaging unit 1 are read out.

As show in the time charts in FIG. 8 and FIG. 9, pixel mixing in a horizontal direction can be performed in the S/H unit 6 in FIG. 5A without increasing circuit scale. More specifically, a plurality of S/H capacitances 40 in the S/H unit 6 also function as a mixer circuit which mixes pixels in a horizontal direction (row direction).

FIG. 5B shows an example of the S/H circuit and the surrounding circuit in the case where pixels in the vertical direction (column direction) are mixed in the S/H unit 6. FIG. 5B shows a S/H circuit 6b corresponding to one column and a MUX circuit 7b corresponding to the one column. By including the S/H circuit 6b and the MUX circuit 7b instead of including each S/H circuit 6a and each MUX circuit 7a as in FIG. 5A, it is possible to mix three pixels in a vertical direction. In this case, the three S/H capacitances 40 in the S/H circuit 6b are caused to sample and hold three pixel signals in a vertical direction.

As described with reference to the drawings, the solid-state imaging device according to the first embodiment of the present invention includes: the imaging unit 1 including pixel units 2 arranged in rows and columns, the pixel units generating pixel signals each according to the amount of light received; the row select circuit 3 which selects at least one row of the pixel units; column signal lines 18 which are respectively provided for the columns, and transmit pixel signals from the selected at least one row of the pixel units; column amplifiers (amplifier element AMP) which are respectively provided for the columns, and each of which includes an input terminal and an output terminal, the input terminal being connected to the corresponding column signal line and each of the column amplifiers outputting an amplified pixel signal through the output terminal; switch circuits 4b which are respectively provided for the columns, and each of which switches ON and OFF of the corresponding column amplifier; and bypass circuits 4c which are respectively provided for the columns, and each of which allows a pixel signal to bypass from the input terminal to the output terminal of the corresponding column amplifier when the corresponding column amplifier is OFF. With this, when still image capture with high-quality and high-resolution is required, signal amplification is performed by the column amplifier and the all-pixel readout mode is used, and when moving image capture for a monitor, such as an electronic viewfinder, is performed, it is made such that operation current does not flow through the column amplifier.

Furthermore, the solid-state imaging device and its driving method according to the first embodiment of the present invention have a feature that the pixel mixing mode is used when it is made such that the operation current does not flow through the column amplifier. Furthermore, the solid-state imaging device and its driving method according to the first embodiment of the present invention has a feature that pixel mixing is performed in the horizontal readout unit in the pixel mixing mode.

With this, signal amplification is performed by the column amplifier in the all-pixel readout mode. Noise may occur in each circuit unit, but the signal amplification can reduce the influences of the noise generated in the subsequent circuits of the column amplifier, thereby allowing still image capture with high-quality and high-resolution.

Furthermore, by using the pixel mixing mode when capturing a moving image for a monitor for an electronic viewfinder, it is possible to suppress power consumption generated in the column amplifier without causing output image defect (moiré occurrence). This also prevents image degradation due to leak current increase, and abnormal operation in the control circuit. As a result, it is possible to expand degree of freedom of the electronic viewfinder that can be used, such as temperature and time.

Note that the image quality of the solid-state imaging device according to the present invention does not degrade greatly even thinning operation of the pixel rows are performed. Thus, when an interlaced scan is used in a liquid crystal panel for a monitor or for an electronic viewfinder in a digital single lens reflex camera having a live-view function (i.e., in a single lens reflex camera which captures moving images for a monitor, that is, for live-view display, using a CMOS image sensor), it is preferable to perform pixel mixing in a horizontal direction as in FIG. 5A and FIG. 9 of the present embodiment.

On the other hand, in a camera having an auto focus (AF) function using contrast in a horizontal direction, it is preferable to perform pixel mixing in a vertical direction instead of a horizontal direction, so that the resolution in the horizontal direction does not degrade.

In this case, pixel mixing in a vertical direction can be implemented such that a plurality of S/H capacitances are provided for each column, pixel signals from several rows are read out to the S/H circuit, and the signals of the S/H capacitances in each column are simultaneously read out to the common horizontal signal line 43.

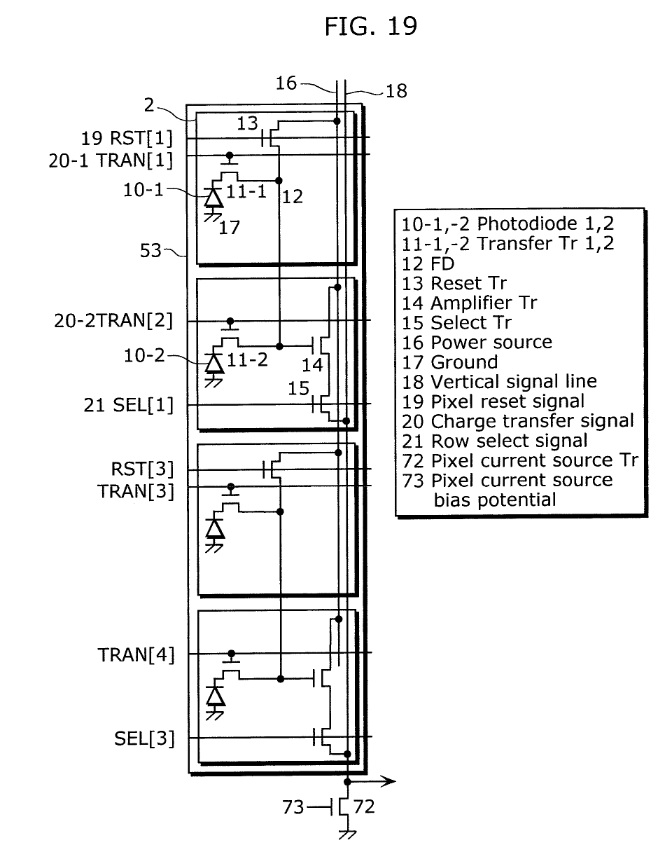

Furthermore, when pixel mixing in a vertical direction is performed, and also when a column amplifier includes a feedback capacitance element and an input capacitance element as in FIG. 4, it is preferable to perform such mixing prior to the column amplifier Tr. In this case, it is also possible to perform mixing in the input capacitance element, which provides an advantageous effect that no additional circuit is necessary. Furthermore, for example, performing pixel mixing prior to the column amplifier as much as possible as in FIG. 19 which is to be described later, is preferable in the image quality, since noise is reduced while there is not much noise mixing.

Further, different from FIG. 4, in the case where the amplifier element of the column amplifier is a type which has a resistant feedback or has no feedback, it is preferable to perform pixel mixing in the subsequent stages of the column amplifier. In this case, for example, as in FIG. 5B, it is possible to avoid having an additional circuit by performing pixel mixing in the S/H circuit.

### Second Embodiment

Hereinafter, a solid-state imaging device according to the second embodiment of the present invention will be described with reference to the drawings; however, the portions which are not described in the following are the same as those described in the above described embodiment 1.

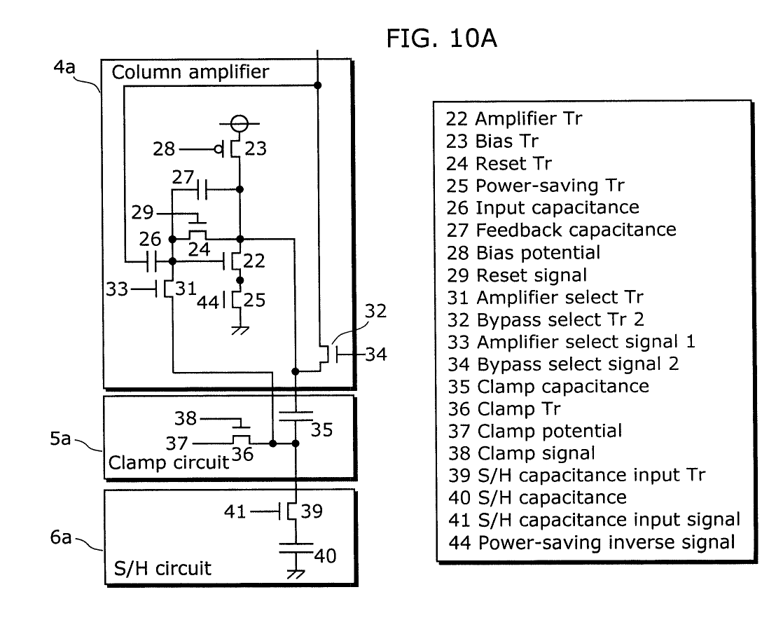

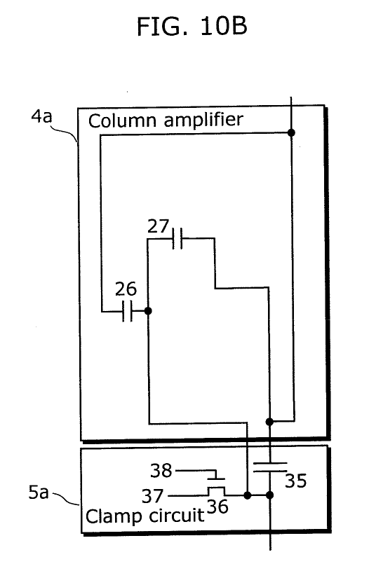

First, FIG. 10A is a diagram showing the details of a column circuit (a column amplifier 4a, a clamp circuit 5a, and a S/H circuit 6a) of the solid-state imaging device according to the second embodiment of the present invention.

As seen in FIG. 10A, the column amplifier 4a includes an input capacitance 26 (capacitance value Cin) which has one terminal to which signals from the pixel units are inputted; an amplifier Tr 22 which has a gate connected to the other terminal of the input capacitance 26, and which amplifies the signals from the pixel units 2; a column amplifier bias Tr 23 which has a gate connected to a column amplifier bias potential, and which supplies driving current to the amplifier Tr 22; a feedback capacitance 27 (capacitance value Cfb) which determines the degree of signal amplification performed by the amplifier Tr 22; a column amplifier reset Tr 24 which has a gate to which a column amplifier reset signal 29 is supplied, and which performs a reset operation for setting the drain output of the amplifier Tr 22 to a predetermined potential; a column amplifier power-saving Tr 25 which has a gate to which a power-saving inverse signal 44 is supplied, and which blocks current flowing through the amplifier Tr 22; a column amplifier output select Trl (31) which has a gate to which an output select signal 1 (33) is supplied, and which connects the terminal potential of the input capacitance 26 at the amplifier Tr 22 side with the clamp capacitance 35 at the S/H circuit 6a side; and a column amplifier output select Tr 2 (32) which has a gate to which an output select signal 2 (34) is supplied, and which directly connects the input terminal and the output terminal.

Further, the clamp circuit 5a includes: a clamp capacitance 35 (capacitance value Ccl) which determines the difference between a reset signal inputted from the column amplifier 4a and a read signal, that is, a pixel signal; and a clamp Tr 36 which has a gate to which a clamp signal 38 is supplied, and which sets, to the clamp potential VCL, the potential of the terminal of the clamp capacitance 35 at the side opposite to the column amplifier 4a.

Further, when the power-saving inverse signal 44 is at H level, the output select signal 1 (33) is at L level, and the output select signal 1 (34) is at L level, the column amplifier 4a amplifies signals from the pixel units 2 and outputs the amplified signals to the clamp circuit 5a. At this time, the gain A is given by Cin/Cfb.

On the other hand, when the power-saving inverse signal 44 is at L level, the output select signal 1 (33) is at H level, and the output select signal 1 (34) is at H level, signals from the pixel units 2 are directly outputted to the clamp circuit 5a. FIG. 10B shows an equivalent circuit of the column amplifier at this time. As shown in FIG. 10B, the input capacitance 26 and the feedback capacitance 27 are also connected to the clamp capacitance in parallel, thereby effectively increasing the capacitance value of the clamp capacitance 35. Further, since the column amplifier power-saving Tr is OFF, current from the column amplifier bias Tr 23 is being blocked.

Further, a pixel reset signal (RST), a charge transfer signal (TRAN), and a row select signal (SEL) are supplied to the pixel circuit (FIG. 1 through FIG. 4) at a predetermined timing. A column amplifier power-saving inverse signal 44, a column amplifier reset signal, an output select signal 1 (33), an output select signal 2 (34), a clamp signal 38, a S/H capacitance input signal 41, a column select signal H[n] are supplied to the column circuit and the MUX at a predetermined timing. Then, transistors corresponding to each control signal are opened or closed (switched ON or OFF).

The solid-state imaging device includes an all-pixel readout mode and a pixel mixing mode. Next, each signal readout operation is described.

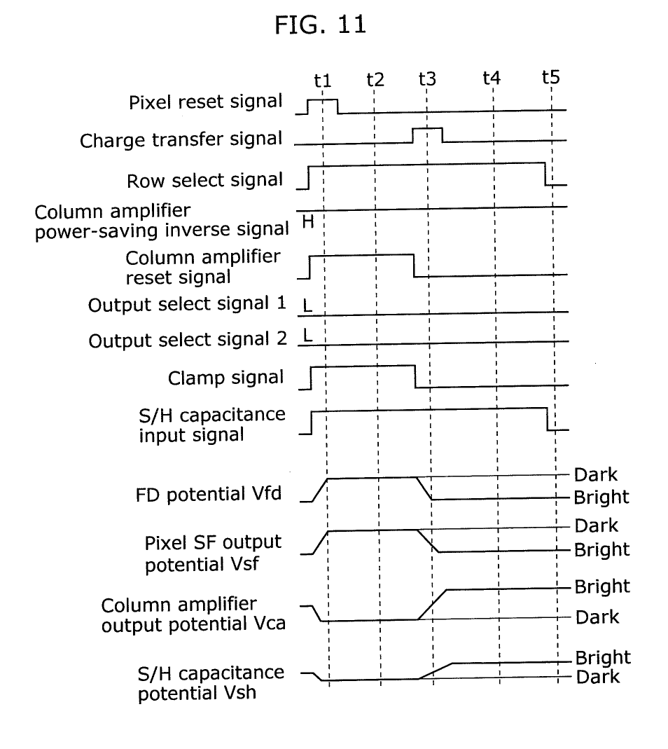

FIG. 11 is a diagram showing timing of each control signal supplied to the pixel units 2 and the column circuit (the column amplifier 4a, the clamp circuit 5a, and the S/H circuit 6a) in the all-pixel readout mode.

Since the power-saving inverse signal 44 is at H level, the output select signal 1 (33) is at L level, and the output select signal 1 (34) is at L level, the column amplifier amplifies signals from the pixel units 2 and outputs the amplified signals to the clamp circuit 5a.

At time t1, the transfer Tr 11 is OFF, and the reset Tr 13 is ON, and the potential of the FD 12 (hereinafter referred to as Vfd) is initialized to the FD reset potential Vfdrsrt (=VDD).

At time t2, the transfer Tr 11 and the reset Tr 13 are OFF; and thus, the potential of the FD 12 (reset status) is maintained. At this time, since the select Tr 15 is ON, the amplifier Tr 14 and the pixel current source Tr 72 form a source follower circuit, so that Vfdrst-Vth is outputted to the vertical signal line 18 as a reset voltage (although Vfdrst-Vth should be indicated as Vfdrst-Vth-α to be exact, α is omitted here). Furthermore, the reset voltage Vfdrst-Vth is inputted to the column amplifier 4a. The column amplifier reset signal 29 is at H level; and thus, the gate and the drain of the amplifier Tr22 are shorted, so that the drain voltage becomes constant potential Vcarst which does not depend on the signal from the pixel unit 2, and the drain voltage is outputted to one terminal of the clamp capacitance 35. On the other hand, the clamp signal and the S/H capacitance input signal 41 are at H level; and thus, the other terminal of the clamp capacitance 35 and the potential of the S/H capacitance 40 are set to VCL.

At time t3, the transfer Tr 11 is switched ON; and thus, charge accumulated in the PD 10 is transferred to the FD 12. As a result, the Vfd lowers by voltage Vfdsig corresponding to the signal charge amount, and becomes Vfdrst-Vfdsig.

At time t4, the transfer Tr 11 is OFF, and the select Tr 15 is ON; and thus, Vfdrst-Vfdsig-Vth is outputted to the vertical signal line 18 as a read voltage. As a result, the input of the column amplifier 4a changes by Vfdsig; and thus, the output of the column amplifier 4a rises by Vfdsig×A (this is because the column amplifier reset signal is at L level, and the reset status of the column amplifier is released). Here, the gain A is given by Cin/Cfb.

Further, since the clamp Tr is OFF, the potential of the other terminal of the clamp capacitance 35, that is, the potential of the S/H capacitance 40 rises by Vfdsig×A×Ccl/(Ccl+Csh). Here, Csh indicates the capacitance value of the S/H capacitance 40.

Such potential change is a voltage corresponding to the difference between the reset voltage and read voltage in the vertical signal line, that is, a pixel signal. At time t5, the S/H input signal is brought to the L level, and the pixel signal is written to the S/H capacitance 40. Due to the above, pixel signals obtained from one row are held by the S/H circuits.

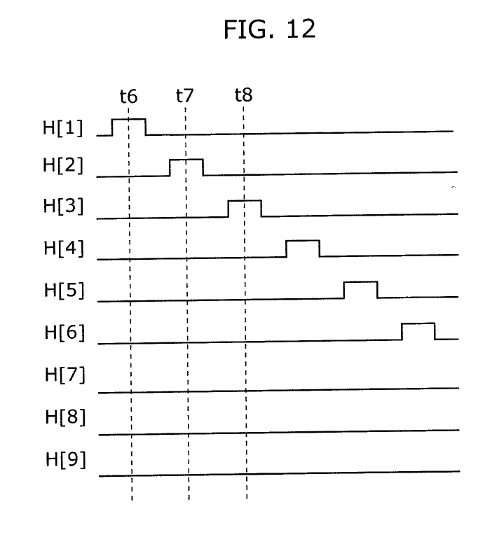

Next, FIG. 12 is a diagram showing timing of each control signal supplied to the MUX in the all-pixel readout mode. As in the first embodiment, by sequentially bringing the column select signals to the H level, signals of the S/H capacitance 40 in each column are sequentially outputted. Due to the above, pixel signals obtained from one row are sequentially outputted.

Further, when operations in FIG. 11 and FIG. 12 are repeated as many as the number of rows that are in the imaging unit 1, signals in the whole imaging unit 1 are read out.

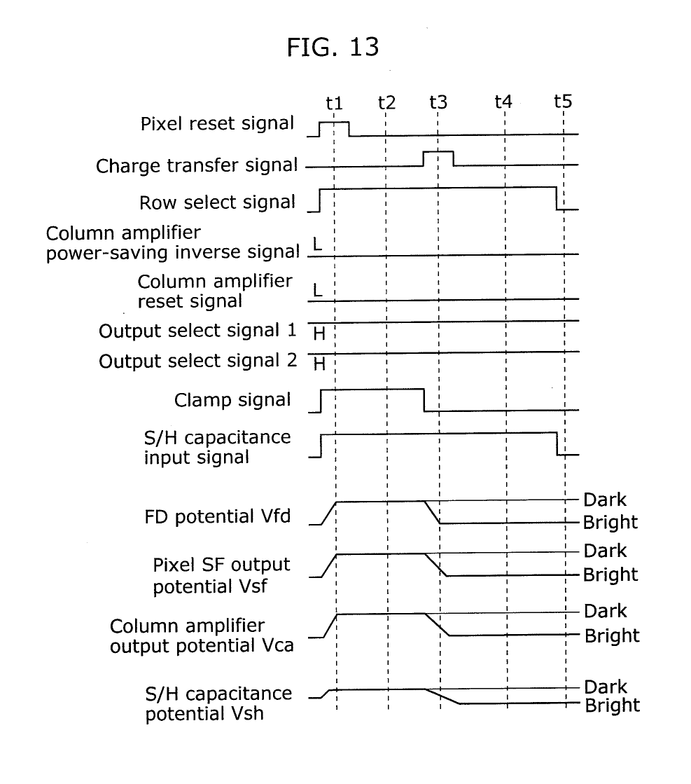

FIG. 13 is a diagram showing timing of each control signal supplied to the pixel units 2 and the column circuit in the pixel mixing mode.

Since the power-saving inverse signal 44 is at L level, the output select signal 1 (33) is at H level, and the output select signal 1 (34) is at H level, the input to the column amplifier 4a is directly outputted to the clamp circuit 5a without being amplified. At time t1, the transfer Tr 11 is OFF, the reset Tr 13 is ON, and the potential of the FD (hereinafter referred to as Vfd) is initialized to the FD reset potential Vfdrsrt (=VDD).

At time t2, the transfer Tr 11 and the reset Tr 13 are OFF; and thus, the reset status of the FD potential is maintained. At this time, since the select Tr 15 is ON, the amplifier Tr 14 and the pixel current source Tr 72 form a source follower circuit, so that Vfdrst-Vth is outputted to the vertical signal line as a reset voltage (though Vfdrst-Vth should be indicated as Vfdrst-Vth-α to be exact, α is omitted here). Further, the reset voltage Vfdrst-Vth is inputted to one terminal of the clamp capacitance 35. On the other hand, the clamp signal and the S/H capacitance input signal are at H level; and thus, the other terminal of the clamp capacitance 35 and the potential of the S/H capacitance 40 are set to VCL.

At time t3, the transfer Tr 11 is switched ON; and thus, charge accumulated in the PD 10 is transferred to the FD. As a result, the Vfd lowers by voltage Vfdsig corresponding to the signal charge amount, and becomes Vfdrst-Vfdsig. At time t4, the transfer Tr 11 is OFF, and the select Tr 15 is ON; and thus Vfdrst-Vfdsig-Vth is outputted to the vertical signal line as a read voltage. As a result, the input of the clamp capacitance 35 changes by Vfdsig. Further, since the clamp Tr is OFF, the potential of the other terminal of the clamp capacitance 35, that is, the potential of the S/H capacitance 40 lowers by Vfdsig×(Cin+Cfd+Ccl)/(Cin+Cfd+Ccl+Csh). Such potential change is a voltage corresponding to the difference between the reset voltage and read voltage in the vertical signal line, that is, a pixel signal. At time t5, the S/H input signal is brought to the L level, and the pixel signal is written to the S/H capacitance 40.

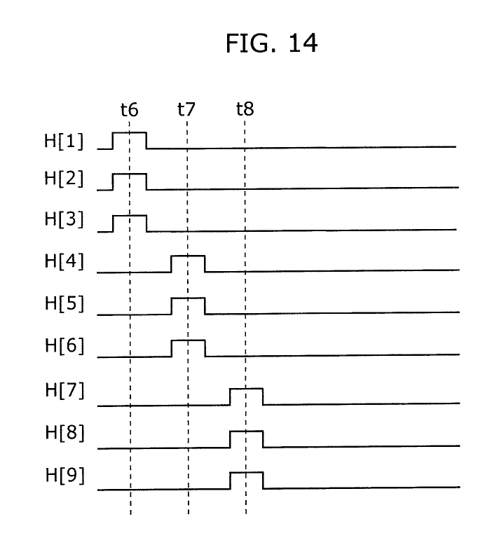

Due to the above, pixel signals obtained from one row are held by the S/H circuits. Next, FIG. 14 is a diagram showing timing of each control signal supplied to the MUX in the pixel mixing mode. As in the first embodiment, when sets of three column select signals are sequentially brought to the H level, the signals of the S/H capacitance 40 in each column are sequentially mixed and outputted. Due to the above, mixed pixel signals obtained from one row are sequentially outputted. Further, when operations in FIGS. 13 and 14 are repeated as many as the number of rows that are in the imaging unit 1, signals in the whole imaging unit 1 are read out.

As described, in the solid-state imaging device and its driving method according to the second embodiment of the present invention, signal amplification is performed in the column amplifier unit 4 in the all-pixel readout mode, thereby reducing the influences of noise generated in the subsequent circuits of the column amplifier unit 4. As a result, high-quality and high-resolution still image capture is possible. On the other hand, in the pixel mixing mode, power consumption can be suppressed since operation current does not flow through the column amplifier unit 4, thereby making it possible to capture a moving image for a monitor, in a wide range of environmental temperature.

Further, signal amplification is not performed in the column circuit, but pixel mixing is performed in the horizontal readout unit; and thus, the influences of noise can be reduced, and the high-quality image can be maintained. Furthermore, the gain of the clamp circuit 5a in the first embodiment is given by Ccl/(Ccl+Csh), but in the present embodiment, the gain of the clamp circuit 5a is given by (Cin+Cfd+Ccl)/(Cin+Cfd+Ccl+Csh). For example, letting Ccl=Csh=Cin=Cfd=1 pF, the gain in the first embodiment is 0.5, but it is 0.75 in the present embodiment. As such, by making the input capacitance 26 and the feedback capacitance 27 function as the clamp capacitance 35, the gain of the clamp circuit 5a increases, and the influences of noise can also be suppressed.

### Third Embodiment

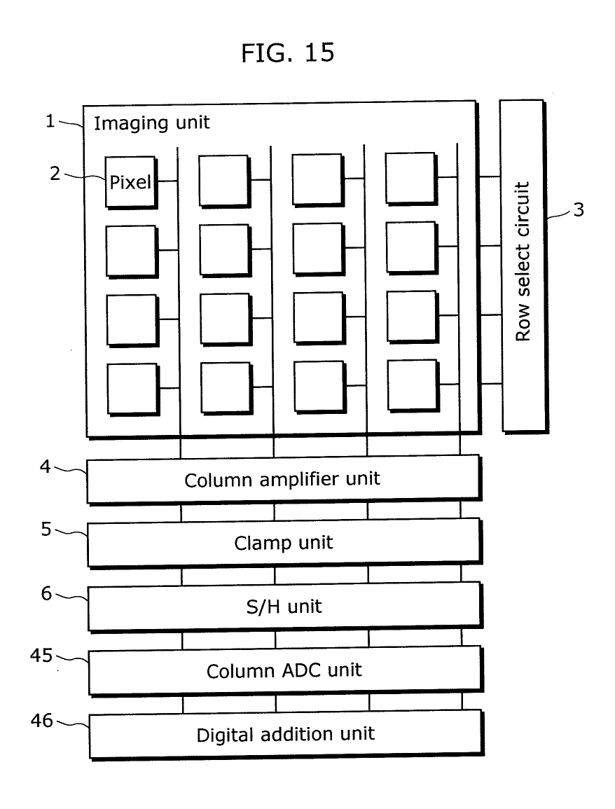

FIG. 15 is a diagram showing an overall structure of a solid-state imaging device according to the third embodiment of the present invention. The solid-state imaging device includes an imaging unit 1, a row select circuit 3, a column amplifier unit 4, a clamp unit 5, a sample and hold (S/H) unit 6, a column ADC unit 45, and a digital addition unit 46.

The column ADC unit 45 includes a plurality of column ADCs 45a, each of which is a basic unit, and which are arranged in a row direction, and converts analog pixel signals that are obtained on a row by row basis and held by the S/H unit 6 into digital signals.

The digital addition unit 46 includes digital adders, each of which is a basic unit, and which are arranged in a row direction, and perform addition of output data supplied from the column ADC unit 45.

The details of the imaging unit 1, the column amplifier unit 4, the clamp unit 5, and the S/H unit 6 are the same as those described in the first embodiment and the second embodiment.

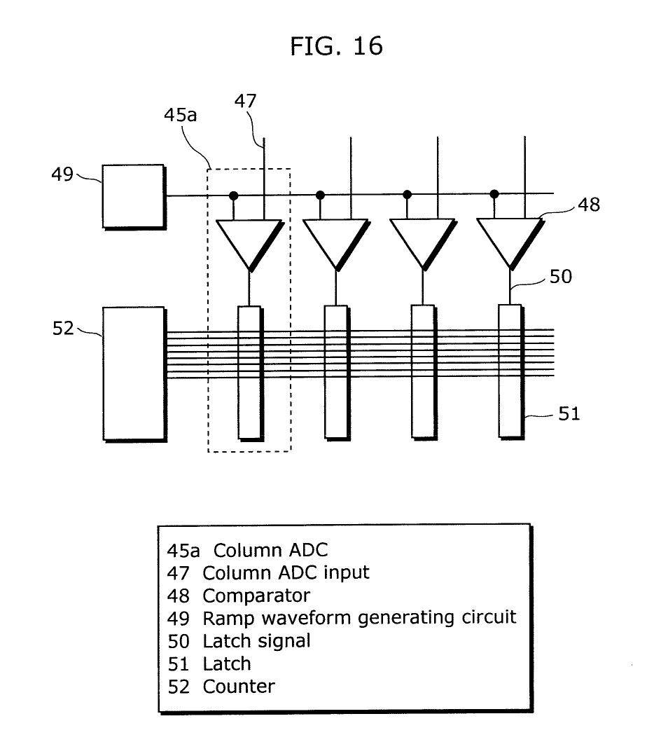

FIG. 16 shows the details of the column ADC unit 45. The column ADC unit 45 includes: a plurality of column ADC 45a, each of which is a basic unit; a ramp wave generating circuit 49; and a counter 52. The ramp wave generating circuit 49 and the counter 52 are shared by each column ADC 45a. Each column ADC 45a includes a comparator 48 and a latch 51. The comparator 48 receives the signal from the S/H circuit 6, compares the received signal with the ramp waveform, and outputs an H level signal when the ramp waveform is lower than the pixel signal. The counter 52 counts up in synchronization with the ramp waveform. The latch 51 receives the output of the counter, and writes the count value of the counter 52 to inside when the latch signal which is a comparison result of the comparator 48 is switched from H level to L level.

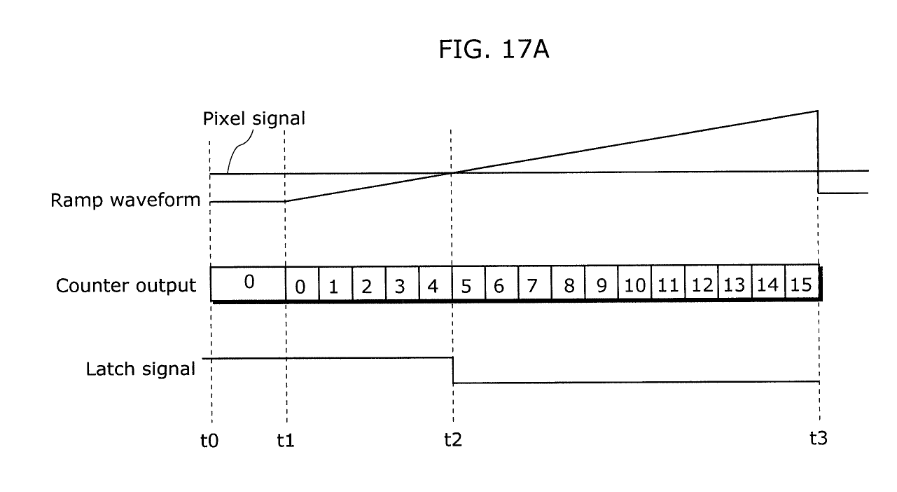

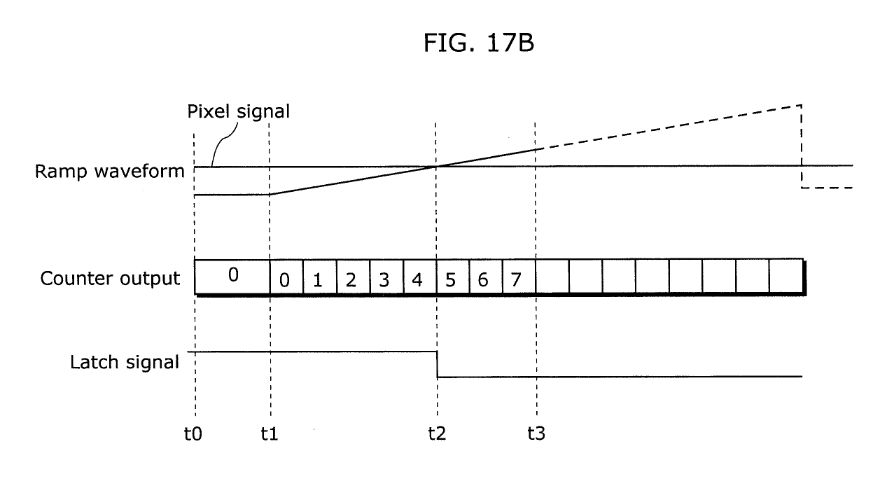

Next, AD conversion operation of the column ADC 45a is described with reference to the timing chart in FIG. 17A. First, the pixel signal is inputted at time t0, the ramp waveform is set to the minimum value of the pixel signal, and the count 52 is set to zero. Further, since the ramp waveform is at lower level than the pixel signal, the latch signal is at H level. Next, at time t1, the level of the ramp waveform starts to rise. The upward slope is set so as to attain the maximum value of the pixel signal at time t3. The counter 52 is also made to count up in synchronization with the rise of the ramp waveform. At time t2, the ramp waveform becomes higher than the pixel signal; and thus the latch signal is brought to the L level, and the counter value at that moment is written into the latch 51. As described earlier, the rise in the ramp waveform and counting up are synchronized; and thus the digital value written into the latch 51 is a value corresponding to the pixel signal. The above operation is performed for each column in parallel, analog pixel signals obtained from one row are AD-converted in parallel, and the converted signals are held by the latch for each column.

The solid-state imaging device includes an all-pixel readout mode and a pixel mixing mode. Next, each signal readout operation is described.

In the all-pixel readout mode, first, pixel signals obtained from one row in the imaging unit 1 are read out, amplified by the column amplifier unit 4, and then held by the S/H unit 6. Next, the pixel signals obtained from one row are converted into digital signals by the column ADC unit 45. At the last, those digital signals are sequentially outputted to the outside of the chip through an output unit which is not described in FIG. 15. When the above operation is repeated as many as the number of rows that are in the imaging unit 1, signals in the whole imaging unit 1 are read out.

The pixel signals obtained from one row in the imaging unit 1 are also read out first in the pixel mixing mode; however, the readout signals are held by the S/H circuit 6 without being amplified by the column amplifier unit 4. At this time, since the column amplifier unit 4 is OFF, electric power is not consumed. Next, the pixel signals obtained from one row are converted into digital signals by the column ADC unit 45. Subsequently, the digital addition unit performs addition of the digital pixel signals of a plurality of columns. At the last, those added digital signals are sequentially outputted to the outside of the chip through an output unit which is not described in FIG. 15. When the above operation is repeated as many as the number of rows that are in the imaging unit 1, signals in the whole imaging unit 1 are read out.

In the all-pixel readout mode, signal amplification is performed by the column amplifier; and thus, the influences of noise generated in the subsequent stages of the column amplifier unit 4 are reduced. As a result, high-quality and high-resolution still image capture is possible. On the other hand, in the pixel mixing mode, power consumption can be suppressed since operation current does not flow through the column amplifier unit 4, thereby making it possible to perform continuous image capture in a wide range of environmental temperature. Further, signal amplification is not performed in the column circuit, but pixel mixing is performed in the digital addition unit; and thus, the influences of noise can be reduced, and the high-quality image can be maintained.

Note that here, the signals that are obtained from the same row are added in the digital addition unit 46; however it may be that signals obtained from a plurality of rows are held, and the pixels obtained from different rows are mixed.

Further, in the pixel mixing mode, since signal amplification is not performed in the column amplifier unit 4, signal amplitude becomes small. Thus, it may be that the input range of each column ADC 45a may be made to be narrower as shown in FIG. 17B. In FIG. 17B, the amplitude of the ramp waveform and the counter operation is made to be half of those described in FIG. 17A. This provides an advantageous effect that AD conversion period becomes shorter, and the frame rate increases. Although the bit precision in AD conversion is reduced, the bit precision can be restored by performing pixel mixing in the subsequent stage.

### Fourth Embodiment

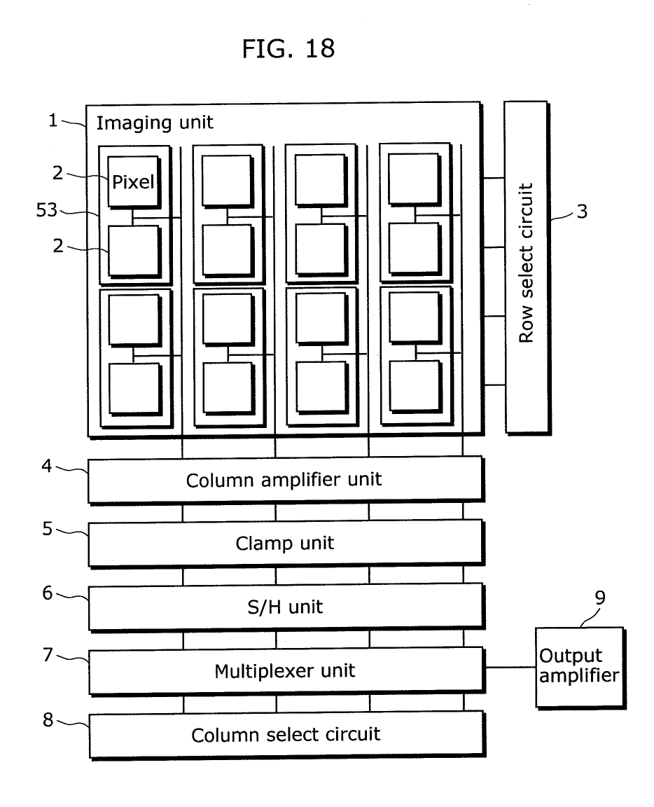

FIG. 18 is a diagram showing an overall structure of a solid-state imaging device according to the fourth embodiment of the present invention. The solid-state imaging device includes an imaging unit 1, a row select circuit 3, a column amplifier unit 4, a clamp unit 5, a sample and hold (S/H) unit 6, a multiplexer unit (MUX) 7, a column select circuit 8, and an output amplifier 9.

The imaging unit 1 is an imaging area in which pixel cells 53 are two-dimensionally arranged. Each pixel cell 53 includes two pixel units 2 which are arranged in a vertical direction, and which performs photoelectric conversion. Here, an example of eight pixel cells which are two dimensionally arranged by 4×2 is shown; however, the actual total pixels are over several mega pixels.

FIG. 19 is a circuit diagram showing the details of the pixel units 2 arranged in a column direction. Each pixel cell 53 has a feature in that the pixel cell 53 outputs, to a vertical signal line, reset voltage in which voltage at the time of initialization is amplified, and read voltage in which voltage at the time of readout is amplified. Each pixel cell 53 includes: two photodiodes PD10-1, and 10-2 which photoelectrically convert incident light and output charge; a floating diffusion (FD) 12 which accumulates the charge generated by the PD10-1 and PD10-2, and outputs the accumulated charge as a voltage signal; a reset Tr 13 which resets the voltage indicated by the FD12 to an initial voltage (hereinafter, referred to as VDD); transfer transistors 11-1 and 11-2 which provide the charge outputted by the PD10-1 and PD10-2 to the FD 12; an amplifier Tr 14 which outputs voltage which changes following the voltage indicated by the FD12; and a select Tr 15 which connects output of the amplifier Tr 14 to the vertical signal line 18 upon receiving a row select signal from the row select circuit. In the first embodiment, two pixels include eight transistors; however, in the present embodiment, two pixels include five transistors, which indicates significant reduction in the number of components.

The details in FIG. 18 are the same as those described in the first embodiment except the imaging unit 1. The solid-state imaging device includes an all-pixel readout mode and a pixel mixing mode. Next, each signal readout operation is described.

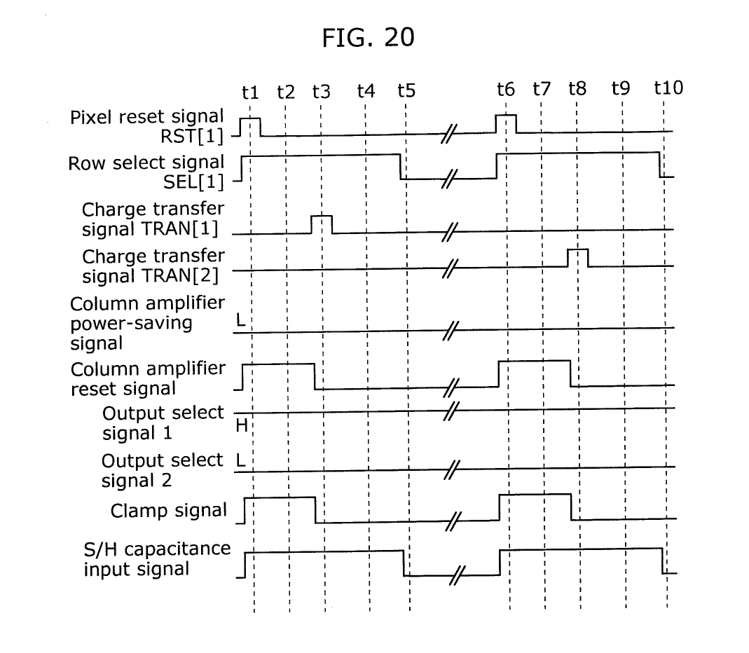

FIG. 20 is a diagram showing timing of each control signal supplied to the pixel units 2 and the column circuit in the all-pixel readout mode (readout portion of the row 1 and the row 2 are shown). The power-saving signal is at L level, the output select signal 1 (33) is at H level, and the output select signal 1 (34) is at L level; and thus, the column amplifier 4a amplifies a pixel signal and outputs the amplified signal to the clamp circuit 5a. At time t1, the reset Tr 13 is ON, and the potential of the FD 12 (hereinafter referred to as Vfd) is initialized to the FD reset potential Vfdrsrt (=VDD).

At time t2, the reset Tr 13 is OFF; and thus, the potential of the FD 12 (reset status) is maintained. At this time, since the select Tr 15 is ON, the amplifier Tr 14 and the pixel current source Tr 72 form a source follower circuit, so that the reset voltage corresponding to Vfdrst is inputted to the column amplifier 4a.

At time t3, the transfer Tr 11-1 at the PD 10-1 side is switched ON; and thus, charge accumulated in the PD 10-1 are transferred to the FD 12. As a result, Vfd lowers by voltage corresponding to the signal charge amount.

At time t4, the transfer transistors 11-1, 11-2 are OFF, and the select Tr 15 is ON; and thus the potential corresponding to the potential of the FD12 is outputted to the vertical signal line 18 as a read voltage. The read signal is amplified by the column amplifier 4a, and inputted to the clamp circuit 5a.

In the clamp circuit 5a, voltage corresponding to the difference between the reset voltage and read voltage, that is, a pixel signal, is detected. At time t5, the detected pixel signal is written to the S/H capacitance 40. Due to the above, the pixel signals obtained from the row 1 are held by the S/H circuits 5a. The signals held by the S/H circuit 5a are sequentially outputted to the outside of the chip through the MUX unit 7 and the output amplifier 9.

Next, at time t6, the reset Tr 13 is ON, and the potential of the FD 12 (hereinafter, referred to as Vfd) is initialized to the FD reset potential Vfdrsrt (=VDD).

At time t7, since the reset Tr 13 is OFF, the potential of the FD (reset status) is maintained. At this time, since the select Tr 15 is ON, the reset voltage corresponding to Vfdrst is inputted to the column amplifier 4a.

At time t8, the transfer Tr 11-2 at the PD 10-2 side is switched ON; and thus, charge accumulated in the PD 10-2 is transferred to the FD 12. As a result, the Vfd lowers by voltage corresponding to the signal charge amount.

At time t9, the transfer transistors 11-1 and 11-2 are OFF, and the select Tr 15 is ON; and thus, the potential corresponding to the FD potential is outputted to the vertical signal line 18 as a read voltage.

The read signal is amplified by the column amplifier 4a, and inputted to the clamp circuit 5a.

In the clamp circuit 5a, voltage corresponding to the difference between the reset voltage and read voltage, that is, a pixel signal, is detected. At time t10, the detected pixel signal is written to the S/H capacitance 40. Due to the above, pixel signals obtained from the row 2 are held by the S/H circuits.

The signals held by the S/H circuit 5a are sequentially outputted to the outside of the chip through the MUX unit 7 and the output amplifier 9. When the above operation is repeated as many as half the number of rows that are in the imaging unit 1, signals in the whole imaging unit 1 are read out.

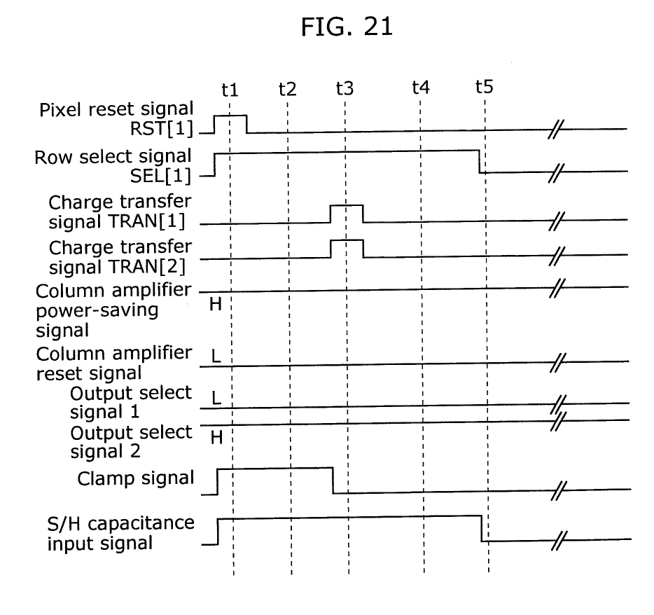

FIG. 21 is a diagram showing timing of each control signal supplied to the pixel units 2 and the column circuit (the column amplifier 4a, the clamp circuit 5a, the S/H circuit 6a) in the pixel mixing mode (the readout portion of the row 1 and the row 2 are shown). The power-saving signal 30 is at H level, the output select signal 1 (33) is at L level, and the output select signal 1 (34) is at H level; and thus, the input to the column amplifier 4a is directly outputted to the clamp circuit 5a without being amplified.

At time t1, the reset Tr 13 is ON, and the potential of the FD 12 (hereinafter, referred to as Vfd) is initialized to the FD reset potential Vfdrst (=VDD).

At time t2, since the reset Tr 13 is OFF, the reset status of the FD potential is maintained. At this time, since the select Tr 15 is ON, the amplifier Tr 14 and the pixel current source Tr 72 form a source follower circuit. As a result, the reset voltage corresponding to Vfdrst is inputted to the column amplifier.

At time t3, both the transfer Tr 11-1 at the PD 10-1 side and the Tr 11-2 at the PD 10-2 side are switched ON; and thus, charges accumulated in the PD 10-1 and PD 10-2 are transferred to the FD 12, and mixed in the FD 12. As a result, the Vfd lowers by voltage corresponding to the mixed signal charge amount.

At time t4, the transfer transistors 11-1 and 11-2 are OFF, and the select Tr 15 is ON; and thus, the potential corresponding to the FD potential is outputted to the vertical signal line 18 as a mixed read voltage.

The mixed read signal is amplified by the column amplifier 4a, and inputted to the clamp circuit 5a. In the clamp circuit 5a, voltage corresponding to the difference between the reset voltage and read voltage, that is, a mixed pixel signal, is detected. At time t5, the detected pixel signal is written to the S/H capacitance 40. Due to the above, mixed pixel signals obtained from the row 1 are held by the S/H circuits 6a. The mixed signals held by the S/H circuits 6a are sequentially outputted to the outside of the chip through the MUX unit 7 and the output amplifier 9. When the above operations are repeated as many as half the number of rows that are in the imaging unit 1, signals in the whole imaging unit 1 are read out.

In the all-pixel readout mode, signal amplification is performed by the column amplifier; and thus, the influences of noise generated in the subsequent stages of the column amplifier are reduced. As a result, high-quality and high-resolution still image capture is possible. On the other hand, in the pixel mixing mode, power consumption can be suppressed since operation current does not flow through the column amplifier, thereby making it possible to capture a moving image for a monitor, in a wide range of environmental temperature. Further, signal amplification is not performed by the column amplifier, but pixel mixing is performed in the pixel unit 2; and thus, the influences of circuit noise can be reduced, and high-quality image can be maintained.

Here, a case has been described where each cell includes two pixels and two photodiodes share the reset Tr 13, the amplifier Tr 14, and the select Tr 15. However, a case where each cell includes more pixels, for example, four pixels, can also obtain the same effects.

### Fifth Embodiment

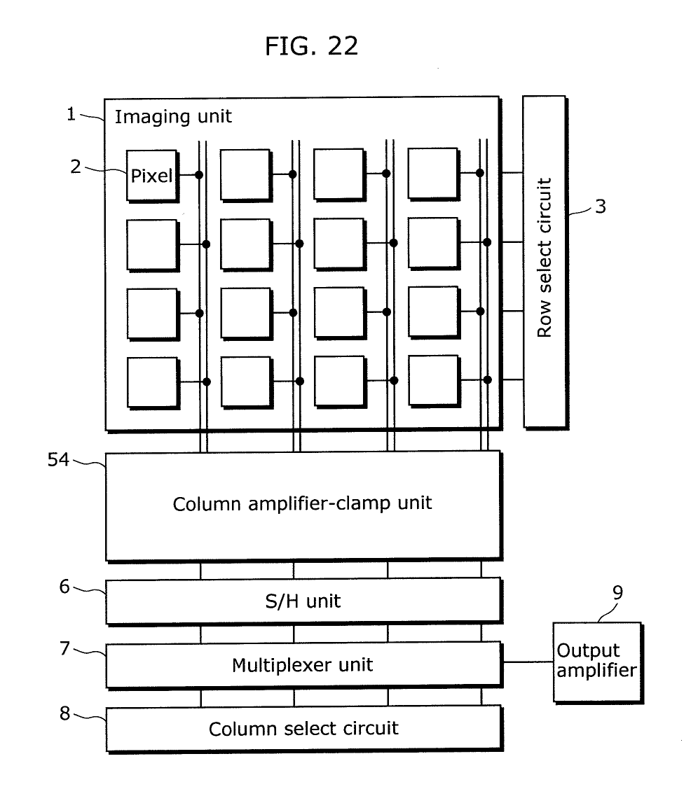

FIG. 22 is a diagram showing an overall structure of a solid-state imaging device according to the fifth embodiment of the present invention.

As seen in FIG. 22, the solid-state imaging device includes an imaging unit 1, a row select circuit 3, a column amplifier-clamp unit 54, a sample and hold (S/H) unit 6, a multiplexer (MUX) unit 7, a column select circuit 8, and an output amplifier 9. The imaging unit 1 is an imaging area in which pixel units 2, each performing photoelectric conversion, are two-dimensionally arranged. Here, an example of 16 pixels which are two dimensionally arranged by 4×4 is shown. Two vertical signal lines are provided for each column, and each pixel is connected to the vertical signal lines alternately for each row. The column amplifier-clamp unit 54 includes column amplifier-clamp circuits 54a, each of which is a basic unit, and which are provided for each column. The S/H unit 6 includes S/H circuits 6a, each of which is a basic unit, and which are provided for each column.

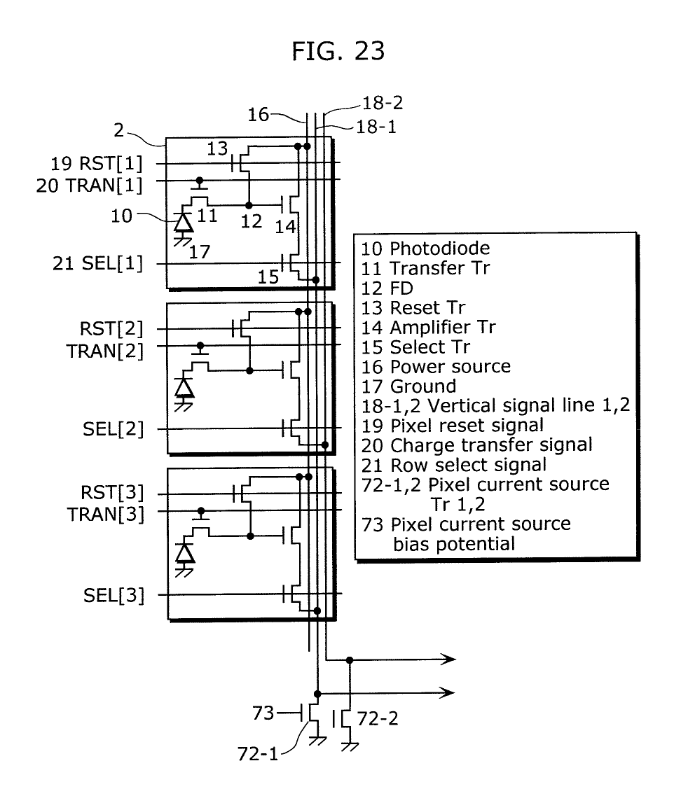

FIG. 23 is a circuit diagram showing the details of the pixel units 2 arranged in a column direction. The pixel circuit is the same as that described in the first embodiment.

The present embodiment differs from the first embodiment in that there are two vertical signal lines for each column. The select Tr 15 of the pixel in the row 1 and the select Tr 15 of the pixel in the row 3 are connected to the vertical signal line 1 (18-1), and the select Tr 15 of the pixel in the row 2 is connected to the vertical signal line 2 (18-2).

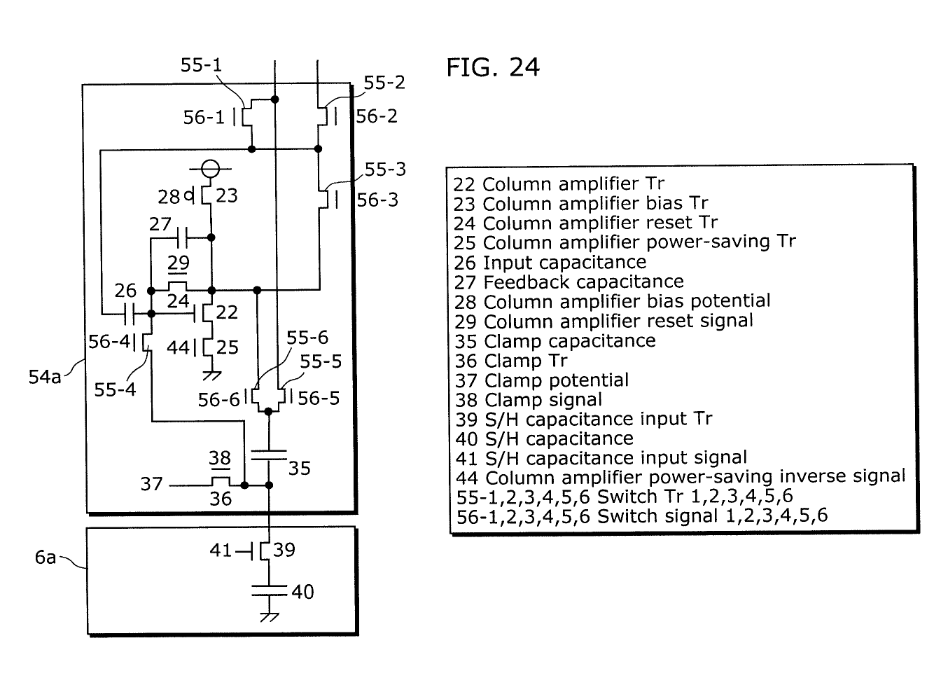

Next, FIG. 24 is a diagram showing the details of a column circuit made up of a column amplifier-clamp circuit 54a, and a S/H circuit 6a.

As seen in FIG. 24, the column circuit has a function which temporarily holds signals that are from the pixel units 2 and are supplied from the vertical signal line 1 or 2, and then outputs the signals to the MUX unit 7. The column circuit also has a function which mixes signals that are from the pixel units 2 and are supplied from the vertical signal lines 1 and 2, temporarily holds the mixed signals, and then outputs the signals to the MUX unit 7. These functions can be switched over.

Further, the column amplifier-clamp circuit 54a includes: an input capacitance 26 (capacitance value Cin) which has one terminal to which signals from the pixel units 2 are inputted; an amplifier Tr 22 which has a gate connected to the other terminal of the input capacitance 26, and which amplifies the signals from the pixels; a column amplifier bias Tr 23 which has a gate connected to a column amplifier bias potential, and which supplies driving current to the amplifier Tr 22; a feedback capacitance 27 (capacitance value Cfb) which determines degree of signal amplification performed by the amplifier Tr22; a column amplifier reset Tr 24 which has a gate to which a column amplifier reset signal 29 is supplied, and which performs a reset operation for setting output of the column amplifier-clamp circuit 54a to a predetermined potential; a column amplifier power-saving Tr 25 which has a gate to which a power-saving inverse signal 44 is supplied, and which blocks current flowing through the amplifier Tr 22; a clamp capacitance 35 (capacitance value Ccl) which receives the output of the column amplifier-clamp circuit 54a, and which determines the difference between the reset signal and the read signal, that is, a pixel signal; a clamp Tr 36 which has a gate to which a clamp signal is supplied, and which sets, to the clamp potential VCL, the terminal potential of the clamp capacitance 35 at the side opposite to the column amplifier-clamp circuit 54a; switch transistors 55-1 and 55-2 which selectively connect signals of the vertical signal lines 1 and 2 to the input capacitance 26; a switch Tr 55-3 which connects the signal of the vertical signal line 2 to the feedback capacitance 27; a switch Tr 55-4 which connects the terminal of the input capacitance 26 at the side opposite to the pixel unit 2 with the terminal of the clamp capacitance 35 at the side opposite to the column amplifier-clamp circuit; a switch Tr 55-5 which connects the signal of the vertical signal line 1 to the clamp capacitance 35; and a switch Tr 55-6 which connects the output of the amplifier Tr to the clamp capacitance 35. Hereinafter, the switch signals 56-1 through 56-6 are simply referred to as switch signals 1 through 6.

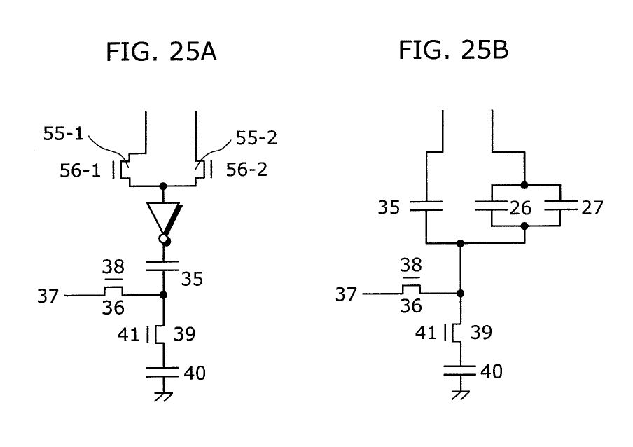

Next, FIG. 25A is a diagram showing an equivalent circuit of the column circuit in FIG. 24 in the all-pixel readout mode. FIG. 25B is a diagram showing an equivalent circuit of the column circuit in FIG. 24 in the mixing mode in a vertical direction.

More specifically, when the power-saving inverse signal 44 is brought to the H level, the switch signals 1 and 2 are alternately brought to the H level, the switch signals 3, 4, and 5 are brought to the L level, and the switch signal 6 is fixed to the H level, the structure of the column circuit becomes equivalent to that in FIG. 25A. As a result, the signals from the vertical signal lines 1 and 2 are alternately supplied to the column amplifier-clamp circuit, and the amplified pixel signals are held by the S/H capacitance 40.

Further, when the power-saving inverse signal 44 is brought to the L level, the switch signal 1 is fixed to the L level, the switching signals 2, 3, 4, and 5 are brought to the H level, and the switch signal 6 is fixed to the L level, the column circuit becomes equivalent to that in FIG. 25B. As a result, the clamp capacitance 35 is provided between the vertical signal line 18-1 and the S/H capacitance 40, and the input capacitance 26 and the feedback capacitance 27 are provided between the vertical signal line 18-2 and the S/H capacitance 40.

As a result, the input capacitance 26 and the feedback capacitance 27 function as a clamp capacitance for the signals of the vertical signal line 2, and the signals of the vertical signal lines 1 and 2 are mixed and written to the S/H capacitance 40. Note that in this setting, current flowing through the column amplifier Tr 22 is being blocked.

As seen in FIG. 25A and FIG. 25B, a pixel reset signal (RST), a charge transfer signal (TRAN), and a column select signal (SEL) are supplied to the pixel units 2 and the column circuit at a predetermined timing. A column amplifier power-saving inverse signal 44, a column amplifier reset signal 29, switch signals 1 to 6, a clamp signal 38, a S/H capacitance input signal 41 are supplied to the column circuit at a predetermined timing. Then, transistors corresponding to each control signals are opened and closed (switched ON or OFF).

Further, the solid-state imaging device according to the fifth embodiment of the present invention includes an all-pixel readout mode and a pixel mixing mode.

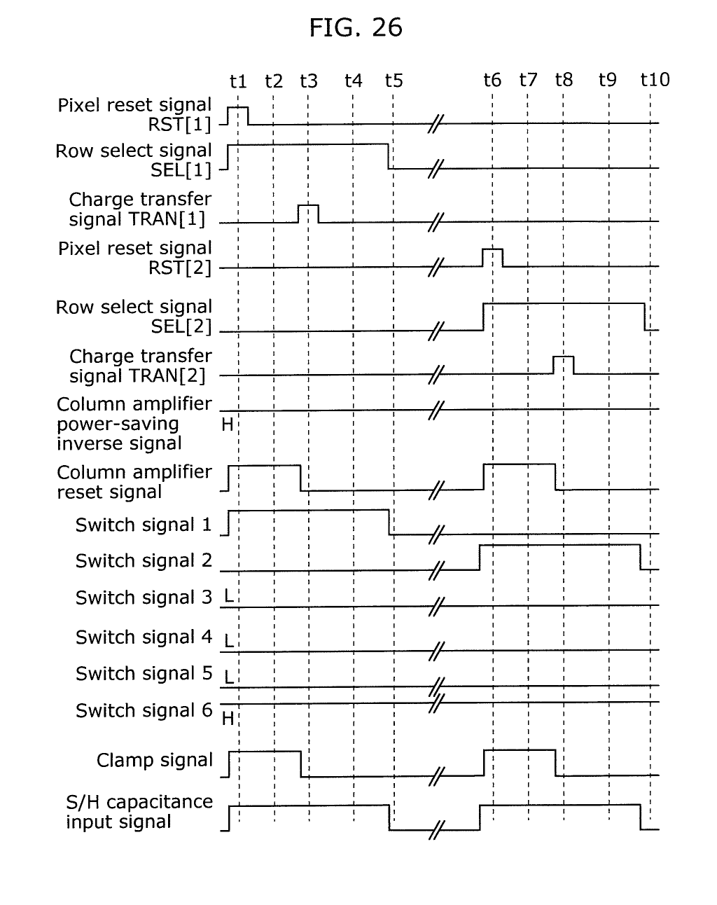

Hereinafter, each signal readout operation is described with reference to the drawings. FIG. 26 is a diagram showing timing of each control signal supplied to the pixel units 2 and the column circuit in the all-pixel readout mode (the readout portion of the row 1 and the row 2 are shown). Since the power-saving inverse signal 44 is at H level, the switch signals 1 and 2 are alternately at H level, the switch signals 3, 4, and 5 are at L level, and the switch signal 6 is fixed to H level, signals from the vertical signal line 1 or 2 are amplified in the column amplifier-clamp circuit 54a and held by the S/H capacitance 40.

At time t1, the reset transfer Tr 13 in the row 1 is ON, and the potential of the FD 12 (hereinafter referred to as Vfd) in the row 1 is initialized to the FD reset potential Vfdrsrt (=VDD).

At time t2, since the reset Tr 13 in the row 1 is OFF, the reset status of the FD potential in the row 1 is maintained. At this time, since the select Tr 15 in the row 1 is ON, the amplifier Tr 14 in the row 1 and the pixel current source Tr 72 form a source follower circuit. In addition, since the select Tr 15 is ON, the reset voltage corresponding to Vfdrst is inputted to the column amplifier-clamp circuit through the vertical signal line 1.

At time t3, the transfer Tr 11 in the row 1 is switched ON; and thus, charge accumulated in the PD 10 in the row 1 is transferred to the FD. As a result, The Vfd lowers by voltage corresponding to the signal charge amount.

At time t4, the transfer Tr 11 in the row 1 is OFF, and the select Tr 15 in the row 1 is ON; and thus, the potential corresponding to the FD potential is outputted to the vertical signal line 1 as a read voltage.

The read signal is amplified in the column amplifier-clamp circuit 54a, and voltage corresponding to the difference between the reset voltage and the read voltage, that is, a pixel signal in the row 1, is detected. At time t5, the detected pixel signal in the row 1 is written to the S/H capacitance 40. Due to the above, pixel signals in the row 1 are held by the S/H circuits. The pixel signals in the row 1 held by the S/H circuit are sequentially outputted to the outside of the chip through the MUX unit and the output amplifier.

Next, at time t6, the reset Tr 13 in the row 2 is ON, and the potential of the FD in the row 2 (hereinafter referred to as Vfd) is initialized to the FD reset potential Vfdrsrt (=VDD).

At time t7, since the reset Tr 13 in the row 2 is OFF, the reset status of the FD potential in the row 2 is maintained. At this time, the select Tr 15 in the row 2 is ON, and the switch signal 2 is ON; and thus, the reset voltage corresponding to Vfdrst is inputted to the column amplifier-clamp circuit 54a.

At time t8, the transfer Tr 11 in the row 2 is switched ON; and thus, charge accumulated in the PD 10 in the row 2 is transferred to the FD 12 in the row 2. As a result, Vfd lowers by voltage corresponding to the signal charge amount.

At time t9, the transfer Tr 11 in the row 2 is OFF, and the select Tr 15 is ON; and thus, the potential corresponding to the FD potential is outputted to the vertical signal line 2 as a read voltage.

The read signal is amplified in the column amplifier-clamp circuit 54a, and voltage corresponding to the difference between the reset voltage and the read voltage, that is, a pixel signal in the row 2, is detected. At time t10, the detected pixel signal in the row 2 is written to the S/H capacitance 40.

Due to the above, pixel signals in the row 2 are held by the S/H circuits 6a. The signals held by the S/H circuit 6a are sequentially outputted to the outside of the chip through the MUX unit 7 and the output amplifier 9. When the operations in FIG. 26 are repeated as many as half the number of rows that are in the imaging unit 1, signals in the whole imaging unit 1 are read out.

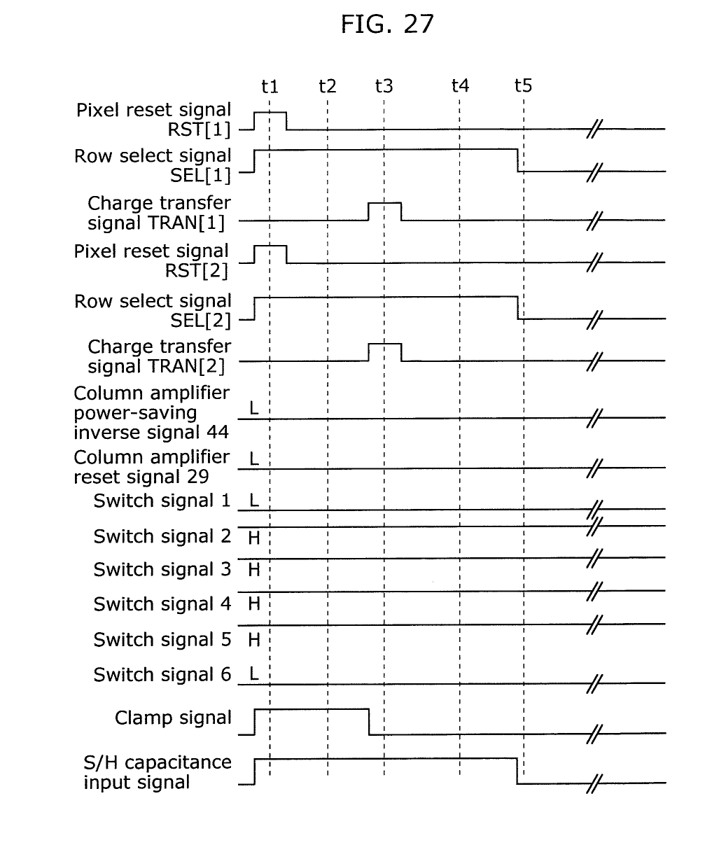

FIG. 27 is a diagram showing timing of each control signal supplied to the pixel units 2 and the column circuit in the pixel mixing mode (the readout portion of the row 1 and the row 2 are shown).

As seen in FIG. 27, the power-saving inverse signal 44 is at L level, the switch signal 1 is fixed to L level, the switch signals 2, 3, 4, and 5 are at H level, and the switch signal 6 is fixed to L level. Thus the column amplifier-clamp circuit 54a does not perform amplification, but the signals of the vertical signal lines 1 and 2 are mixed and written to the S/H capacitance 40.

At time t1, the reset transistors 13 in the row 1 and the row 2 are ON, and the potentials of the FD 12 (hereinafter referred to as Vfd) in the row 1 and the row 2 is initialized to the FD reset potential Vfdrsrt (=VDD).

At time t2, since the reset transistors 13 in the row 1 and the row 2 are OFF, the reset status of the FD potentials in the rows 1 and 2 is maintained. At this time, since the select transistors 15 in the row 1 and the row 2 are ON, the amplifier Tr 14 and the pixel current source Tr 72 form a source follower circuit. As a result, the reset voltage corresponding to Vfdrst in the row 1 is inputted to the clamp capacitance 35 through the vertical signal line 1, and the reset voltage corresponding to Vfdrst in the row 2 is inputted to the input capacitance 26 and the feedback capacitance 27 through the vertical signal line 2.

At time t3, the transfer transistors 11 in the rows 1 and 2 are ON; and thus, charges accumulated in the PD in the rows 1 and 2 are transferred to the corresponding FD. As a result, Vfd lowers by voltage corresponding to the signal charge amount.

At time t4, the transfer transistors 11 in the row 1 and the row 2 are OFF, and the select transistors in the rows 1 and 2 are ON. Thus, the potential corresponding to the FD potential in the row 1 is inputted to the clamp capacitance 35 through the vertical signal line 1 as a read voltage. The potential corresponding to the FD potential in the row 2 is inputted to the input capacitance 26 and the feedback capacitance 27 through the vertical signal line 2 as a read voltage.

At this time, a mixed signal of the voltage corresponding to the difference between the reset voltage and the read voltage in the row 1, that is, a pixel signal in the row 1, and the voltage corresponding to the difference between the reset voltage in the row 2 and the read voltage, that is, a pixel signal in the row 2, is detected. At time t5, the detected mixed signal is written to the S/H capacitance 40. Due to the above, mixed pixel signals of the rows 1 and 2 are held by the S/H circuits 6a. The mixed pixel signals held by the S/H circuit 6a are sequentially outputted to the outside of the chip through the MUX unit 7 and the output amplifier 9. When operation in FIG. 27 are repeated as many as half the number of rows that are in the imaging unit 1, mixed signals in the whole imaging unit 1 are read out.

As described, the solid-state imaging device according to the fifth embodiment of the present invention performs signal amplification in the column amplifier-clamp circuit 54a in the all-pixel readout mode, thereby reducing the influences of noise generated after the column amplifier-clamp circuit 54a. As a result, high-quality and high-resolution still image capture is possible. On the other hand, in the pixel mixing mode, power consumption can be reduced since the operation current does not flow through the column amplifier-clamp circuit 54a, thereby making it possible to capture a moving image for a monitor, in a wide range of environmental temperature.

Further, signal amplification is not performed in the column amplifier-clamp circuit 54a, but pixel mixing is performed in the column circuit; and thus, the influences of circuit noise can be reduced, and the high-quality image can be maintained. Furthermore, it is also possible to improve frame rate by reading out pixels obtained from two rows of the imaging unit 1 at the same time.

### Sixth Embodiment

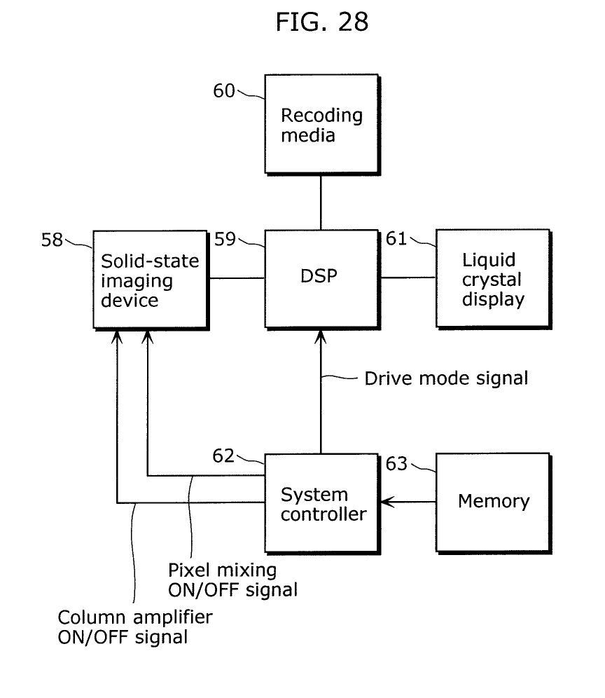

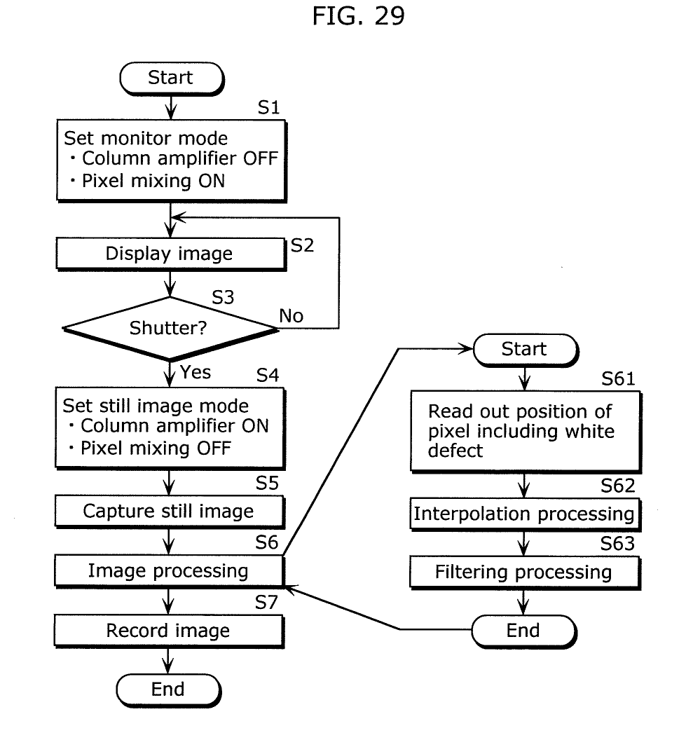

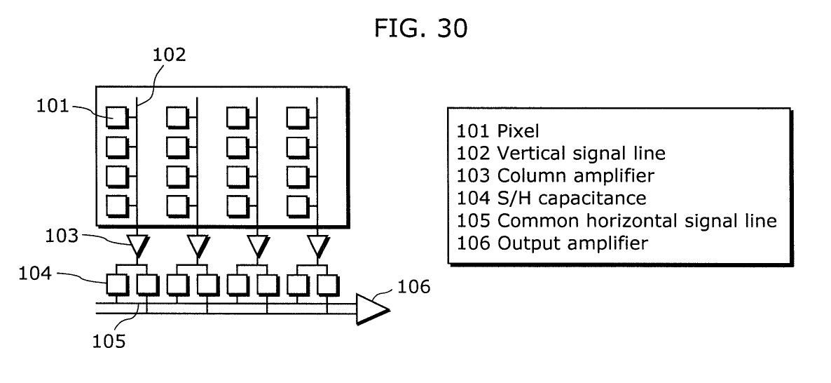

FIG. 28 is a diagram showing a structure of a camera (imaging device) according to the sixth embodiment of the present invention.

As seen in FIG. 28, the camera (imaging device) includes: a solid-stat imaging device 58 which converts input light image information into an electric signal; a digital signal processor (DSP) 59 which performs noise reduction processing and color signal processing on the image signal detected by the solid-state imaging device 58 so as to generate a color image; a recording media 60, such as a semiconductor memory element, for storing the color image; a liquid crystal display 61 which displays the image on the monitor and functions as an electronic viewfinder; a system controller 62 which controls the solid-state imaging device 58, the DSP 61 or the like; and a memory.

Further, the structure of the solid-state imaging device 58 is the same as one of the first embodiment through the fifth embodiment (an ADC is added to the outside when a solid-state imaging device which outputs an analog signal is applied; however, the ADC is omitted here).

FIG. 29 is a flowchart showing a flow of an imaging operation of the camera (imaging device) according to the sixth embodiment of the present invention.

First, a mode for a monitor is set in step S1. The solid-state imaging device switches a column amplifier OFF, and at the same time, switches the pixel mixing mode ON. The DSP makes a setting corresponding to the monitor mode.

In step S2, the solid-state imaging device captures a moving image for a monitor, and displays the captured image on the liquid crystal display. In step S3, a user of the camera determines whether the user has pressed the shutter or not. When not pressed, the processing is returned to Step S2, and capturing a moving image for a monitor and displaying the captured image are performed again. When the shutter is pressed, a still image capture mode is set in step S4. The solid-state imaging device switches the column amplifier off, and the pixel mixing mode off. The DSP makes a setting corresponding to a still image.

In step S5, the solid-state image device captures a still image. In step S6, the DSP performs noise reduction processing and color image processing. In step S7, the color image on which the image processing has been performed is recorded onto the recoding media.

The noise reduction processing included in the image processing in step S6 is shown in steps S61 and S62. Here, the memory 63 stores defective pixel data which indicates the position, in the imaging unit, of the pixel unit that always causes noise. Such defective image data is, for example, set at the time of factory shipment or at the time of inspection.

In step S61, the DSP 59 reads out the defective pixel data stored in the memory. In step S62, the DSP 59 interpolates pixel data corresponding to the position indicated by the defective pixel data, in the image captured by the solid-state imaging device 58. With this interpolation, it is possible to improve image quality by removing pixel signals that become white defects resulting from lattice defects specific to the imaging unit of the solid-state imaging device 58.

Further, in step S63, the DSP 59 further performs filtering processing on the image, thereby reducing noise. As a result, it is possible to make image degradation due to noise generated later in the solid-state imaging device, less noticeable.

In the sixth embodiment of the present invention, electric power is not consumed at the time of capturing moving images for a monitor since the column amplifier is OFF, and the electronic viewfinder can be used for a long period of time regardless of environmental temperature. Further, since pixel mixing is performed according to the resolution degree of the liquid crystal display of the camera, significant image degradation does not occur even when the column amplifier is OFF. Further, due to the power reduction, the level of the pixel defect resulting from PD leak current decreases. Further, due to the pixel mixing, defect level is further reduced, which results in significant reduction in the number of the defective pixel signals to be interpolated. This indicates that performing sufficient interpolation while maintaining frame rate can be facilitated since the processing amount of the interpolation is proportional to the number of defects.

On the other hand, at the time of still image capture, since the column amplifier is ON, high-resolution and high-quality image capture is possible.

At this time, electric power is consumed in the column amplifier; however, it does not become a problem since still image capture is performed for ten times in a row at most.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The solid-state imaging device according to the present invention is useful as an image sensor used in an imaging device for which high-quality image and high functionality are desired, such as a digital single lens reflex camera, a digital single lens camera, and a high grade compact camera.

What is claimed is:

1. A solid-state imaging device comprising:
an imaging unit including pixel units arranged in rows and columns, said pixel units generating pixel signals each according to an amount of light received;
a row select unit which selects at least one row of said pixel units;
column signal lines which are respectively provided for the columns, and transmit pixel signals from the selected at least one row of said pixel units;
amplifier circuits which are respectively provided for the columns, and each of which includes an input terminal and an output terminal, said input terminal being connected to a corresponding one of said column signal lines, each of said amplifier circuits outputting an amplified pixel signal through said output terminal;
switch circuits which are respectively provided for the columns, and each of which switches ON and OFF of a corresponding one of said amplifier circuits; and
bypass circuits which are respectively provided for the columns, and each of which allows a pixel signal to bypass from said input terminal to said output terminal of a corresponding one of said amplifier circuits when the corresponding one of said amplifier circuits is OFF.

2. The solid-state imaging device according to claim 1, further comprising
a mixer circuit which mixes a predetermined number of pixel signals outputted from at least one said output terminal.

3. The solid-state imaging device according to claim 2,
wherein said mixer circuit mixes the predetermined number of the pixel signals when each of said amplifier circuits is OFF.

4. The solid-state imaging device according to claim 3,
wherein each of said switch circuits switches the corresponding one of said amplifier circuits OFF in a moving image capture mode for a monitor, and ON in a still image capture mode.

5. The solid-state imaging device according to claim 2, comprising:
sample-and-hold circuits which are respectively provided for the columns, and each of which samples and holds, in a capacitance element, a pixel signal outputted through said output terminal, said capacitance element being included in each of said sample and hold circuits; and
a column select circuit which selects at least one of said sample and hold circuits,
wherein said column select circuit sequentially selects said sample and hold circuits one by one when each of said amplifier circuits is ON, and said column select circuit sequentially makes a simultaneous selection of the predetermined number of said sample and hold circuits when each of said amplifier circuits is OFF, and
said mixer circuit includes the predetermined number of capacitance elements included in the predetermined number of said sample and hold circuits, and mixes the predetermined number of the pixel signals based on the simultaneous selection.

6. The solid-state imaging device according to claim 2,
wherein said mixer circuit mixes the predetermined number of the pixel signals which are from a same column and are outputted through said output terminal.

7. The solid-state imaging device according to claim 6, comprising:
sample-and-hold circuits which are respectively provided for the columns, and each of which samples and holds, in each of the predetermined number of capacitance elements, a pixel signal outputted through said output terminal, the predetermined number of capacitance elements being included in each of said sample-and-hold circuits; and
a column select circuit which sequentially selects said sample and hold circuits,
wherein each of said sample-and-hold circuits samples and holds the predetermined number of the pixel signals that are from different rows, in the predetermined number of said capacitance elements, when each of said amplifier circuits is OFF, and
said mixer circuit includes the predetermined number of said capacitance elements, and mixes the predetermined number of the pixel signals held based on the selection made by said column select circuit.

8. The solid-state imaging device according to claim 6,
wherein each of said column signal lines includes:
a first signal line; and
a second signal line,
pixel units in a same column, among said pixel units, include:
a pixel unit connected to said first signal line; and
a pixel unit connected to said second signal line,
each of said amplifier circuits includes:
an amplifier element;
an input capacitance element connected between said amplifier element and said input terminal of said amplifier circuit; and
a feedback capacitance element connected between an input and an output of said amplifier element,
said solid-state imaging device further comprises:
clamp circuits which are respectively provided for the columns, and each of which clamps a pixel signal outputted through said output terminal to a clamp capacitance element, said clamp capacitance element being included in each of said clamp circuits,
when the corresponding one of said amplifier circuits is OFF, each of said bypass circuits allows a pixel signal that is from a corresponding first signal line to bypass to said output terminal, and further clamps a pixel signal that is from a corresponding second signal line to at least one of said input capacitance element and said feedback capacitance element, and
said mixer circuit includes said clamp capacitance element and at least one of said input capacitance element and said feedback capacitance element, and mixes the pixel signals which have been clamped, when each of said amplifier circuits is OFF.

9. The solid-state imaging device according to claim 1,
wherein at least two pixel units among said pixel units constitute one cell, the at least two pixel units being adjacent to each other in a same column,
the one cell includes:
a first photoelectric conversion element;
a second photoelectric conversion element;
a floating diffusion layer;
a first transfer unit which transfers a signal charge from said first photoelectric conversion element to said floating diffusion layer;
a second transfer unit which transfers a signal charge from said second photoelectric conversion element to said floating diffusion layer; and
an amplifier unit which converts a signal charge in said floating diffusion layer into a voltage, and outputs the converted voltage as a pixel signal, and
when each of said amplifier circuits is OFF, the signal charge transferred by said first transfer unit and the signal charge transferred by said second transfer unit are mixed in said floating diffusion layer.

10. The solid-state imaging device according to claim 2, further comprising
analog-to-digital (AD) converters which are respectively provided for the columns, and each of which converts a pixel signal outputted through said output terminal into a digital pixel signal,
wherein said mixer circuit mixes the predetermined number of digital pixel signals.

11. The solid-state imaging device according to claim 10,
wherein each of said AD converters is capable of switching an input range of the pixel signal, and
when each of said amplifier circuits is OFF, the input range is narrower than the input range of the case where each of said amplifier circuits is ON.

12. The solid-state imaging device according to claim 1,
wherein each of said amplifier circuits includes:
an amplifier element; and
an input capacitance element inserted between said input terminal of said amplifier circuit and said amplifier element,
said solid-state imaging device further comprises:
clamp circuits which are respectively provided for the columns, and each of which clamps a pixel signal outputted through said output terminal to a clamp capacitance element, said clamp capacitance element being included in each of said clamp circuits; and
connect circuits which are respectively provided for the columns, and each of which connects in parallel said input capacitance element and said clamp capacitance element when each of said amplifier circuits is OFF.

13. The solid-state imaging device according to claim 12,
wherein each of said amplifier circuits further includes a feedback capacitance element inserted between an output and an input of said amplifier element, and
said connect circuit further connects in parallel said feedback capacitance element and said clamp capacitance element when each of said amplifier circuits is OFF.

14. An imaging device comprising:
said solid-state imaging device according to claim 1; and
an image processing unit configured to reduce noise included in an image captured by said solid-state imaging device.

15. The imaging device according to claim 14,
wherein said image processing unit includes:
a storing unit configured to store a position of a pixel unit, among said pixel units, which always causes the noise in said imaging unit; and
an interpolation unit configured to interpolate, in the image captured by said solid-state imaging device, a pixel data corresponding to the position stored in said storing unit.

16. The imaging device according to claim 14,
wherein said image processing unit is configured to reduce the noise by performing filtering processing on the image captured by said solid-state imaging device.

17. A method for driving a solid-state imaging device, the solid-state imaging device including:
an imaging unit including pixel units arranged in rows and columns, the pixel units generating pixel signals each according to an amount of light received;
a row select unit which selects at least one row of the pixel units;
column signal lines which are respectively provided for the columns, and transmit pixel signals from the selected at least one row of the pixel units;
amplifier circuits which are respectively provided for the columns, and each of which includes an input terminal and an output terminal, the input terminal being connected to a corresponding one of the column signal lines, each of the amplifier circuits outputting an amplified pixel signal through the output terminal;
said method for driving the solid-state imaging device, comprising:
detecting a switchover between a moving image capture mode for a monitor and a still image capture mode;
switching each of the amplifier circuits ON when the switchover into the still image capture mode is detected;
switching each of the amplifier circuits OFF when the switchover into the moving image capture mode for a monitor is detected;
allowing a pixel signal to bypass from said input terminal to said output terminal of a corresponding one of said amplifier circuits when the switchover into the motion image capture mode for a monitor is detected; and
mixing a predetermined number of pixel signals outputted from at least one said output terminal.
